(19) United States
(12) Patent Application Publication
(10) Pub. No.: US 2026/0288843 A1
(43) Pub. Date: Sep. 24, 2026

(54) SYSTEM

(71) Applicant: SoftBank Group Corp., Tokyo (JP)

(72) Inventor: Soshi KOYAMA, Tokyo (JP)

(73) Assignee: SoftBank Group Corp., Tokyo (JP)

(21) Appl. No.: 19/563,091

(22) Filed: Mar. 11, 2026

(30) Foreign Application Priority Data
Mar. 19, 2025 (JP) 2025-044547

(51) Int. Cl. G06F 16/34; G06F 16/35; G06F 21/62

(52) U.S. Cl. CPC G06F 16/345; G06F 16/35; G06F 21/6254

(57) ABSTRACT

A system includes a processor that is configured to collect data indicating daily work activities, and automatically perform an evaluation based on a prompt for instructing a generative AI model to perform an evaluation using the generative AI model, integrate an evaluation result generated by the generative AI model, a value evaluation, and a manager evaluation to perform a comprehensive evaluation, and analyze emotion data using an emotion analysis engine in order to analyze an emotional state of a user, and reflect a result of the analysis of the emotion data in the evaluation.

### CROSS-REFERENCE TO RELATED APPLICATION

This application is based on and claims priority under 35 USC 119 from Japanese Patent Application No. 2025-044547 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional employee performance evaluation systems rely heavily on manual input by managers and periodic, subjective assessments, and thus often fail to capture day-to-day work activities in a timely and objective manner. Such systems typically do not leverage detailed operational data such as email activity, online meeting participation, or internal communication logs, and therefore cannot provide fine-grained, data-driven evaluations. In addition, conventional systems generally do not incorporate evaluations generated by generative AI models based on natural language prompts, and thus cannot flexibly adapt evaluation criteria or deeply analyze unstructured information, such as daily reports. Furthermore, traditional evaluation processes rarely take into account the emotional state of each user; as a result, they lack the ability to adjust assessments in light of user stress, motivation, or engagement levels, leading to evaluations that may not accurately reflect the overall condition and potential of employees. Moreover, existing systems often provide only static scores or rankings, without intuitive visualization of performance trends or personalized feedback that clearly indicates concrete strengths and improvement points for each employee. Accordingly, there is a need for a system capable of automatically evaluating daily work activities using generative AI models, integrating multiple evaluation dimensions including value and manager evaluations, reflecting users'emotional states in the evaluation, and providing visualized performance information and individualized feedback to support continuous improvement and motivation.

### SUMMARY

To solve the above-described problems, an aspect of the present invention provides a system comprising a processor, wherein the processor is configured to collect data indicating daily work activities, and automatically perform an evaluation based on a prompt for instructing a generative AI model to perform an evaluation using the generative AI model. The processor is further configured to integrate an evaluation result generated by the generative AI model, a value evaluation, and a manager evaluation to perform a comprehensive evaluation so that both data-driven AI analysis and human assessments are reflected in a unified performance score. Additionally, the processor is configured to analyze emotion data using an emotion analysis engine in order to analyze an emotional state of a user, and reflect a result of the analysis of the emotion data in the evaluation, thereby enabling adjustment of the evaluation in accordance with the user's emotional condition and improving the fairness and context-awareness of the assessment. In one implementation, the processor is further configured to visualize performance of individual employees as a graph or chart based on the evaluation result, whereby users and managers can intuitively recognize performance levels and changes over time. In another implementation, the processor is configured to generate feedback including specific improvement points and strengths based on the evaluation result and the emotional state, and provide the feedback to each individual employee, thus enabling each employee to understand concrete actions for improvement and to leverage identified strengths, thereby supporting continuous skill development and enhancement of motivation.

The term “processor” refers to one or more hardware processing units, such as a central processing unit (CPU), a graphics processing unit (GPU), a microcontroller, or any combination thereof, configured to execute instructions and perform the functions described in the present specification and claims.

The term “data indicating daily work activities” refers to electronic data that represents or is derived from a user's or employee's day-to-day work-related actions, including but not limited to email communications, participation in online meetings, usage of internal communication tools, creation of daily reports, task logs, and other operational records generated during work.

The term “generative AI model” refers to an artificial intelligence model configured to generate outputs, such as text, scores, or other data, based on learned patterns from training data, and includes, for example, large language models, transformer-based models, and other neural network models capable of generating evaluation results from prompts or input data.

The term “prompt” refers to a piece of input information, including text or structured data, that instructs or conditions the generative AI model to perform a specific task, such as evaluating daily work activities, and that defines or influences the evaluation criteria, perspective, or output format.

The term “evaluation result generated by the generative AI model” refers to an output produced by the generative AI model in response to a prompt and work activity data, the output including, for example, scores, ratings, or qualitative assessments that express the performance of a user or employee.

The term “value evaluation” refers to an assessment that indicates the degree to which a user's or employee's behavior or achievements conform to predefined organizational values, corporate philosophies, or competency models, the assessment being provided, for example, by human evaluators or a human resources system.

The term “manager evaluation” refers to an assessment made by a manager or supervisor regarding a user's or employee's performance, attitude, results, or other work-related aspects, typically expressed as a score, rating, or qualitative comment.

The term “comprehensive evaluation” refers to an integrated assessment obtained by combining, aggregating, or weighting multiple evaluation components, including at least the evaluation result generated by the generative AI model, the value evaluation, and the manager evaluation, to produce a unified performance indicator.

The term “emotion data” refers to data representing or indicating an emotional state of a user, such as stress, satisfaction, motivation, or engagement, and may include, for example, sentiment extracted from text, vocal tone features, facial expression data, physiological signals, or explicit self-reported emotional information.

The term “emotion analysis engine” refers to a software and/or hardware component configured to analyze emotion data using statistical methods, machine learning, or rule-based algorithms, and to output an estimated emotional state or emotional indicators for a user.

The term “emotional state” refers to a psychological condition or affective status of a user at a given time or over a period, including, for example, states such as positive, negative, neutral, stressed, motivated, fatigued, or engaged, which can be inferred from emotion data.

The term “visualize performance” refers to the act of representing evaluation results or performance indicators in a graphical or visual format, such as graphs, charts, dashboards, or other visual elements, so that users and managers can intuitively understand performance levels and trends.

The term “graph or chart” refers to a visual representation of numerical or categorical data, including, for example, line graphs, bar charts, pie charts, radar charts, scatter plots, or other types of visual diagrams suitable for displaying evaluation results.

The term “feedback” refers to information generated for a user or employee based on evaluation results and, optionally, emotional states, the information including explanations, comments, suggestions, or guidance intended to inform the user about current performance, strengths, and areas for improvement.

The term “specific improvement points” refers to concrete, actionable indications of aspects in which a user or employee is recommended to change or enhance behavior, skills, or work processes, the indications being derived from analysis of evaluation results and emotional states.

The term “strengths” refers to positive aspects of a user's or employee's performance, abilities, or behaviors that are evaluated as comparatively superior or desirable, and which can be leveraged to maintain or further improve overall performance.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

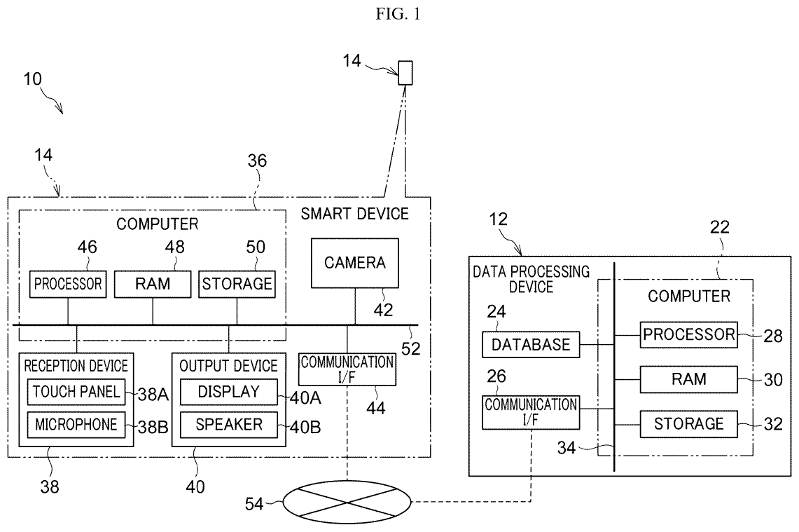

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

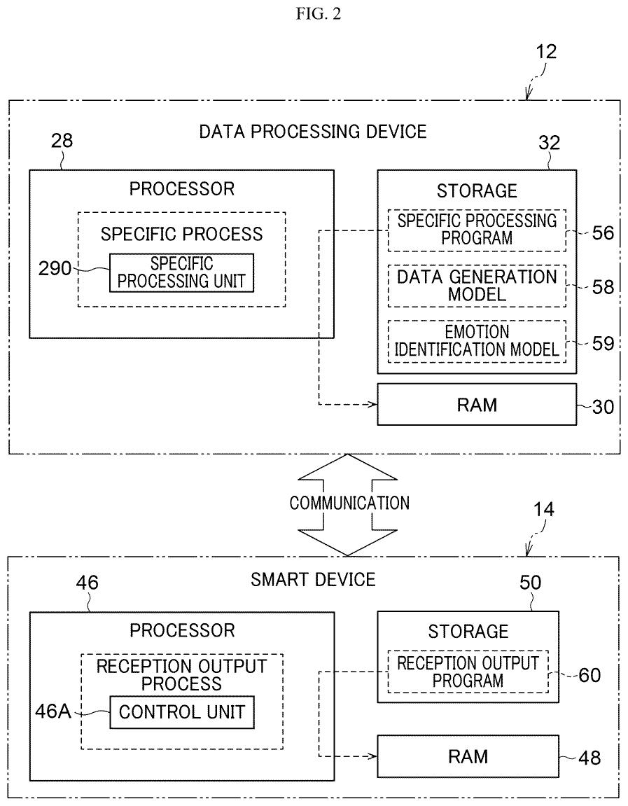

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented employee evaluation systems suffer from several technical limitations in the way activity data is acquired, processed, and evaluated. In many existing systems, daily work activity data such as communication logs, meeting participation records, and report contents are either not collected in a structured and machine-usable manner, or are processed by ad hoc scripts that are tightly coupled to particular applications. As a result, the underlying data pipeline is fragmented, error-prone, and difficult for a computer system to leverage efficiently for automated performance evaluation.

Further, even when machine learning models are used, those systems typically apply fixed, model-specific input formats and static rule-based scoring. They do not dynamically construct input instructions to a generative artificial intelligence model in the form of a prompt sentence that reflects normalized numerical features and processed textual content in an integrated fashion. This leads to suboptimal utilization of computational resources, because the model receives either incomplete context or redundant data, and must perform repeated, inefficient inference steps. The lack of a prompt-driven interface between the data processing pipeline and a generative artificial intelligence model also makes it difficult to adapt the evaluation process to diverse activity patterns and organizational criteria without substantial manual reconfiguration of the system.

Moreover, conventional systems usually treat emotion information and subjective feedback as external, loosely linked data, if they consider such information at all. They do not provide a unified computer-implemented mechanism that analyzes emotion data using an emotion analysis component and programmatically integrates the resulting emotion analysis with multi-source evaluation information, including generative artificial intelligence model output, value-based evaluation, and manager evaluation. Consequently, the computer system cannot produce a technically consistent integrated evaluation result that is automatically usable for subsequent computation, such as visual aggregation, feedback synthesis, and comparison across users and time periods.

In addition, existing systems frequently generate evaluation reports or feedback text through static templates executed by the processor, resulting in repetitive and low-granularity output that does not fully exploit the rich feature space of the underlying activity data and emotion analysis. This template-based approach forces the processor to perform multiple disjoint formatting and rule-application steps, which increase processing overhead and make it difficult to adapt to changes in evaluation logic or data schema.

Accordingly, there is a need for an improved computer-implemented technique that: (i) systematically acquires and stores heterogeneous daily work activity data as structured data, (ii) preprocesses numerical and textual information into a format suitable for use with a generative artificial intelligence model, (iii) automatically generates and supplies a prompt sentence to the generative artificial intelligence model to obtain performance-related evaluation information, (iv) programmatically integrates this evaluation information with additional evaluation sources and emotion analysis results in the processor, and (v) generates structured evaluation summary text and feedback text suitable for efficient visualization and reuse. By addressing these issues, the invention improves the functioning of the computer system itself, including the data pipeline, inference control, and automated content generation within the processor, rather than merely automating a human mental process.

The specific processing by the specific processing unit 290 of the data processing device 12 in Example 1 is realized by the following means.

The present invention provides a server comprising a processor and a storage resource, the processor being configured to collect, from a user terminal, a plurality of types of activity data indicating daily work activities of a worker, and store the activity data as structured data in the storage resource; preprocess the activity data as numerical features and textual information, and convert a result of the preprocessing into an input format for a generative artificial intelligence model; automatically generate a prompt sentence for the generative artificial intelligence model based on the result of the preprocessing, input the prompt sentence to the generative artificial intelligence model, and obtain, in response, evaluation information regarding work performance of the worker; integrate the evaluation information obtained from the generative artificial intelligence model, value-based evaluation information based on a value criterion, and evaluation information provided by a manager, in accordance with a predetermined weighting algorithm executed by the processor, and calculate an integrated evaluation result; analyze, using an emotion analysis component controlled by the processor, emotion data associated with the worker, and reflect an analysis result of the emotion data in the integrated evaluation result; and generate, based on the integrated evaluation result and the analysis result of the emotion data, evaluation summary text and feedback text for the worker, and store the evaluation summary text and the feedback text as output data in the storage resource. This enables an improved computer-implemented evaluation pipeline in which the processor systematically transforms heterogeneous raw activity data into structured data, drives a generative artificial intelligence model through dynamically constructed prompt sentences, algorithmically fuses multi-source evaluation and emotion analysis results, and automatically produces machine-generated textual outputs suitable for efficient visualization and reuse, thereby enhancing the technical performance, scalability, and adaptability of the evaluation system.

The term “system” refers to a combination of hardware and software components, including at least one processor and one storage resource, that cooperatively execute programmed instructions to perform the claimed functions.

The term “processor” refers to one or more hardware processing units, such as a central processing unit or a graphics processing unit, capable of executing machine-readable instructions to perform arithmetic, logical, control, and input/output operations.

The term “storage resource” refers to one or more non-transitory computer-readable media, such as semiconductor memory, magnetic storage, or optical storage, configured to store data and programs used by the processor.

The term “user terminal” refers to an information processing device operated by a human user, such as a personal computer, a mobile terminal, or a tablet device, that communicates activity data and receives evaluation information from the system.

The term “activity data” refers to electronic data indicating daily work activities of a worker, including but not limited to communication records, message counts, email counts, meeting participation records, and digital representations of work reports.

The term “structured data” refers to data represented in a predefined organized format, such as records, fields, or key-value pairs, that can be programmatically stored, indexed, and processed by the processor.

The term “preprocess” refers to a sequence of computer-executed operations that transform raw activity data into a normalized, encoded, or otherwise prepared form, suitable for input to a machine learning or generative artificial intelligence model.

The term “numerical features” refers to quantitative values derived from activity data, such as counts, durations, frequencies, or normalized scores, that can be represented as numeric elements in a feature vector.

The term “textual information” refers to character-based or token-based data derived from text, such as the content of work reports, comments, or messages, that can be processed by natural language processing techniques.

The term “input format” refers to a data representation, such as a feature vector, tensor, or serialized text, that conforms to the requirements of a particular generative artificial intelligence model for performing inference.

The term “generative artificial intelligence model” refers to a machine learning model configured to generate output data, such as text, scores, or structured information, in response to input data, and including but not limited to models based on neural networks and transformer architectures.

The term “prompt sentence” refers to an input text string or sequence of tokens that describes data, instructions, or context for a generative artificial intelligence model, and that guides the model to produce desired output.

The term “evaluation information” refers to information generated by the system regarding work performance of a worker, including numerical scores, qualitative labels, or explanatory text derived from activity data and model inference.

The term “value-based evaluation information” refers to evaluation information representing how a worker's behavior or results align with predefined organizational values or value criteria, typically expressed as scores or ratings.

The term “manager evaluation” refers to evaluation information provided by a human supervisor or manager of the worker, including scores, ratings, and optional comments regarding the worker's performance.

The term “weighting algorithm” refers to a computer-implemented procedure that assigns weights to multiple input evaluation elements and combines them, for example by computing a weighted sum or other composite metric, to obtain an integrated evaluation result.

The term “integrated evaluation result” refers to an evaluation outcome calculated by the processor by combining multiple types of evaluation information, including model-based, value-based, and manager-based evaluations, into a single aggregated result.

The term “emotion analysis component” refers to a software-implemented engine or module executed by the processor that analyzes emotion data, such as sentiment or affective state indicators, to produce emotion analysis results.

The term “emotion data” refers to data indicative of a user's or worker's emotional state, which may be derived from text, voice, facial expression, physiological signals, or explicit input, and which can be processed by the emotion analysis component.

The term “analysis result of the emotion data” refers to a structured output generated by the emotion analysis component, such as emotion categories, sentiment scores, or intensity levels, that represent the interpreted emotional state.

The term “evaluation summary text” refers to a machine-generated natural language description that summarizes the integrated evaluation result and optionally related activity or emotion information for a worker.

The term “feedback text” refers to machine-generated natural language content that indicates specific improvement points, strengths, or recommendations for a worker based on the integrated evaluation result and emotion analysis.

The term “output data” refers to data generated by the processor as a result of performing evaluation, integration, and text generation processes, including evaluation summary text, feedback text, and associated metadata, stored in the storage resource.

The term “time-series information” refers to evaluation-related data organized according to chronological order, such as evaluation scores or metrics associated with respective time points or periods.

The term “factor-wise information” refers to evaluation-related data decomposed by contributing factors, such as separate scores or metrics for communication, reporting, collaboration, or other performance dimensions.

The term “display data” refers to data formatted by the processor for visualization on a display device, including numerical values, labels, and graphical parameters for rendering graphs or charts.

The term “feedback information” refers to structured information, including feedback text and associated identifiers, that conveys specific improvement suggestions or acknowledgments of strengths for a worker and is suitable for presentation on a user terminal.

In one embodiment, a server, a terminal, and a user cooperate to implement a computer-implemented evaluation system as defined by the claims. The server comprises at least one processor and at least one non-transitory storage resource. The server executes program modules that are stored in the storage resource and that cause the processor to perform the operations described in the claims. The terminal comprises a processing unit, a memory, a communication interface, and a display device, and operates as a data acquisition and presentation device for the user.

The server uses general-purpose hardware such as a multi-core central processing unit and, in some embodiments, a graphics processing unit that supports parallel numerical computation. The server runs an operating system such as a server-oriented operating system, and executes middleware such as a web server, an application framework, and a database management system. For example, the server executes a web server, an application server implemented with a framework, and a relational database engine such as a relational database management system. The server executes scientific computing libraries such as numerical computation libraries and data-frame libraries. The server also executes machine learning frameworks such as a computational graph-based framework and a tensor-based deep learning framework. These names are illustrative; the claimed invention is not limited to specific products.

The terminal uses hardware such as a personal computing device, a portable information terminal, or a tablet-type device. The terminal runs a client application such as a web browser or a dedicated native application. The terminal acquires daily work activity data through interaction with communication tools, email clients, online meeting tools, and reporting interfaces. In one example, the terminal monitors, under user consent and according to enterprise policies, sent email counts from a mail client, meeting participation durations from calendar or conferencing applications, post counts from messaging tools, and text content from a report entry screen. The terminal converts these items into structured records, for example using a key-value representation stored in an internal memory. The terminal transmits the structured records to the server via a secure communication protocol, such as a protocol that uses encryption over a packet-switched network.

The server receives the activity data from the terminal and stores the data as structured data in the storage resource. The server stores the data in a plurality of logical tables or collections, such as an activity master table that holds employee identifiers, dates, and source types, and associated tables that hold per-source metrics such as email counts, meeting durations, communication message counts, and textual report content. Each record includes an identifier that links the record to a particular worker and a particular time period. The structured storage enables efficient index-based retrieval, join operations, and time-series aggregation by the processor.

The server preprocesses the stored activity data by using software libraries executed on the processor. The server converts daily counts, durations, and frequencies into numerical features. For example, the server computes email count per day, meeting hours per day, communication posts per day, and character length or token count of report text. The server normalizes these values using statistical operations, such as subtracting a mean and dividing by a standard deviation computed over a department or organizational group. The server stores the resulting numerical feature vectors in a feature table in the database. This data structure enables the processor to perform vectorized computations and reduces the need to repeatedly scan raw logs.

The server processes report text and other textual information by using a natural language processing module. The server tokenizes the text, removes stop words, and converts tokens to vector representations. In one embodiment, the server uses a pre-trained language encoder implemented with a deep neural network that has multiple self-attention layers and feed-forward sublayers. The encoder receives tokenized text, converts tokens to token embeddings, applies position encodings, and propagates the token embeddings through stacked attention blocks. Each attention block computes attention weights by matrix multiplication between query, key, and value matrices derived from the embeddings, and then aggregates contextualized vectors. The final layer output is averaged or pooled to obtain a fixed-length embedding that represents the semantic content of the report text. The server stores these text embeddings as dense numeric arrays in a table that is linked to the original records.

The server combines the normalized numerical features and the text embeddings to build input instances for a generative AI model. The server concatenates or otherwise fuses the numeric vectors and text embeddings into a unified representation. In some embodiments, the server encodes categorical attributes such as department, role, or project type as one-hot or embedding vectors and appends them to the feature vector. This unified representation is stored as an intermediate tensor representation in memory and may also be cached in the database to avoid redundant computations.

The server executes a performance evaluation model that is implemented as a neural network. In one embodiment, the server uses a model with an encoder branch for numerical features (for example, several fully connected layers with non-linear activation functions) and a branch for text embeddings (for example, additional dense layers), followed by a fusion layer that concatenates or adds the outputs. The fusion layer connects to one or more dense layers that output continuous performance scores and feature-specific sub-scores such as communication effectiveness, reporting thoroughness, and collaboration intensity. The model is trained before deployment by using a labeled training dataset, where past activity features and text embeddings are associated with human-assigned performance scores. The server trains the model by minimizing a loss function such as mean squared error or cross-entropy, and updates the network weights by using an optimization algorithm such as stochastic gradient descent or a variant such as adaptive moment estimation. During training, the server may also perform data augmentation, such as noise injection into numeric features or paraphrase generation for text, in order to improve generalization.

The server uses the trained evaluation model in inference mode to compute evaluation information for each worker. The server batches multiple input instances and performs matrix operations on the processor and, in some embodiments, offloads computationally intensive operations to a graphics processing unit that executes kernels for dense linear algebra. This parallel computation improves processing speed and throughput compared to a single-threaded CPU implementation. The server stores the resulting scores and sub-scores in an evaluation result table.

The server then uses a generative AI model to generate natural language output. In one embodiment, the generative AI model is a transformer-based language model with decoder layers, trained on text data including performance narratives and feedback examples. The server constructs a prompt sentence that embeds both numeric and textual context. For example, the server uses a prompt such as:

“Using the following employee activity data, evaluate the employee's performance and generate an overall performance assessment.

### Activity Data:

Number of emails sent today: 50
Online meeting participation time today: 3 hours
Communication tool posts: 20 messages on an internal communication platform
Work report content: ‘Completed the monthly sales analysis, coordinated with the marketing team, and prepared a detailed presentation for the client meeting.’

Please output: (1) a numerical performance score from 0 to 100, and (2) a concise textual explanation of the employee's performance.”

The server embeds, within this prompt sentence, values derived from the feature vector and key textual excerpts from the report. The server inputs the prompt sentence into the generative AI model, which tokenizes the prompt, converts tokens to embeddings, and passes them through multiple self-attention and feed-forward layers. The model uses learned parameters to predict a probability distribution over the next token at each generation step. The server samples or selects tokens according to this distribution to generate an explanation text. By embedding preprocessed, normalized features in the prompt, the server guides the model to focus on relevant aspects of the data, reducing token count and improving inference determinism and latency.

The server executes a weighting algorithm to integrate multiple sources of evaluation information. The server retrieves the evaluation information from the generative AI model (for example, a numerical score or scores extracted from the generated text), retrieves value-based evaluation information assigned according to organizational criteria, and retrieves manager evaluation information entered by supervisors. The server applies a weighting scheme stored in configuration data, for example assigning 0.5 weight to the generative AI evaluation, 0.2 to the value-based evaluation, and 0.3 to the manager evaluation. The server computes a composite score as a weighted sum or by using a non-linear combination such as a logistic function. The server may also compute confidence measures by evaluating the variance or stability of component scores over time.

The server analyzes emotion data associated with the worker by means of an emotion analysis component. In one embodiment, the server obtains emotion data from sources such as textual feedback from the worker, selected icons representing mood, or speech-derived sentiment scores. The server executes an emotion recognition model that uses either a neural network classifier or a hybrid rule-based and machine-learned algorithm. For textual emotion data, the server encodes phrases into embeddings and applies a classifier that outputs sentiment polarity and emotion categories (for example, positive, neutral, negative, or more fine-grained categories). For other modalities, the server processes numerical features derived from signals. The server stores emotion scores and categories in an emotion table.

The server combines the emotion analysis result with the integrated evaluation result. For example, the server may down-weight or flag evaluations where the emotion analysis suggests extreme stress or disengagement, thereby preventing misinterpretation of high activity as purely positive performance. The server may also adjust the wording of feedback text according to the emotion categories, for example using more supportive phrasing for workers in a negative emotional state. This combination is performed by explicit algorithms encoded in the program, and not by ad hoc human interpretation.

The server generates evaluation summary text and feedback text based on the integrated evaluation result and the emotion analysis result. In one embodiment, the server uses the generative AI model again with a tailored prompt sentence that specifies the integrated score, component scores, and emotion categories, and requests specific forms of feedback, such as concrete next actions. Because the server feeds structured numeric and categorical values in a standardized template into the prompt, the model can generate consistent and machine-parseable segments of text. The server also enforces some rule-based constraints, such as limiting length, ensuring inclusion of both strengths and improvement points, and avoiding prohibited terms. The server stores the generated texts and metadata in an output table, enabling later retrieval and audit.

The terminal receives the evaluation summary text, feedback text, and numerical scores from the server and renders them on a dashboard. The terminal parses JSON or another structured response from the server and uses a graphical user interface framework to display charts, tables, and narrative sections. The terminal can display time-series graphs that represent the integrated evaluation result and component scores across multiple evaluation periods, and can show factor-wise breakdowns of communication, meeting participation, and reporting quality. The terminal highlights segments of generated text that correspond to specific score thresholds or emotion states. This visualization uses local rendering resources and does not require manual formatting by the user.

The user interacts with the dashboard on the terminal to interpret the evaluation and, if desired, to provide additional annotations or corrections. The user may adjust weights or thresholds within permitted bounds, and the server may record such adjustments and apply them to future evaluations. The user can also trigger re-generation of feedback text with modified prompts (for example, specifying “generate a summary suitable for a one-on-one review with a junior staff member”), and the server updates the prompt sentence accordingly and repeats the generation process. This interaction demonstrates that the system is not merely automating a fixed business rule, but is dynamically controlling model behavior through prompt design based on structured computational outputs.

The described configuration yields technical effects beyond mere automation of human evaluation. Because the server converts heterogeneous activity data into standardized feature vectors and text embeddings, the server reduces redundancy and improves cache locality in memory. Because the server uses a batched inference procedure on a parallel processing unit, the server increases throughput and decreases latency. By dynamically constructing concise prompt sentences that incorporate only preprocessed, relevant features, the server reduces the amount of text processed per inference, which decreases computation time and network bandwidth in scenarios where an external model endpoint is used. By integrating emotion analysis and multi-source evaluations through explicit algorithms, the server avoids repeated manual reconciliation steps and enables deterministic, reproducible evaluation pipelines.

The server improves accuracy by using a learned evaluation model that captures complex, non-linear relationships among activity metrics and performance outcomes, rather than relying on fixed threshold rules. The server further improves interpretability and consistency by generating summary and feedback texts through a generative AI model that is guided by structured prompts built from normalized data. The combination of model-based scoring, structured weighting, and emotion-aware text generation yields evaluations that are more stable and less biased than scores generated by ad hoc scripts or purely human judgment.

In alternative embodiments, the server may use different model architectures, such as recurrent neural networks, convolutional sequence models, or hybrid models that combine rule-based filters with neural network scoring. The server may store feature vectors in columnar storage to optimize analytical queries, or may partition the database by department or region to improve scalability. The terminal may be implemented as a thin client that performs minimal local computation, or as a richer client that performs local data preprocessing before transmitting compressed features to the server to reduce communication load. The emotion analysis component may be integrated with the generative AI model or may be a separate module that outputs labels and confidence scores that are then used as additional features in the weighting algorithm.

In all of these embodiments, the server, the terminal, and the user interact through defined data structures, algorithms, and model architectures. The system is configured so that the computer hardware performs specific transformations of data—raw activity logs into structured features, features into model inputs, model outputs into integrated scores, and scores into textual summaries—thereby improving computational efficiency, scalability, and reliability of performance evaluation in a way that is not achievable by manual processes alone.

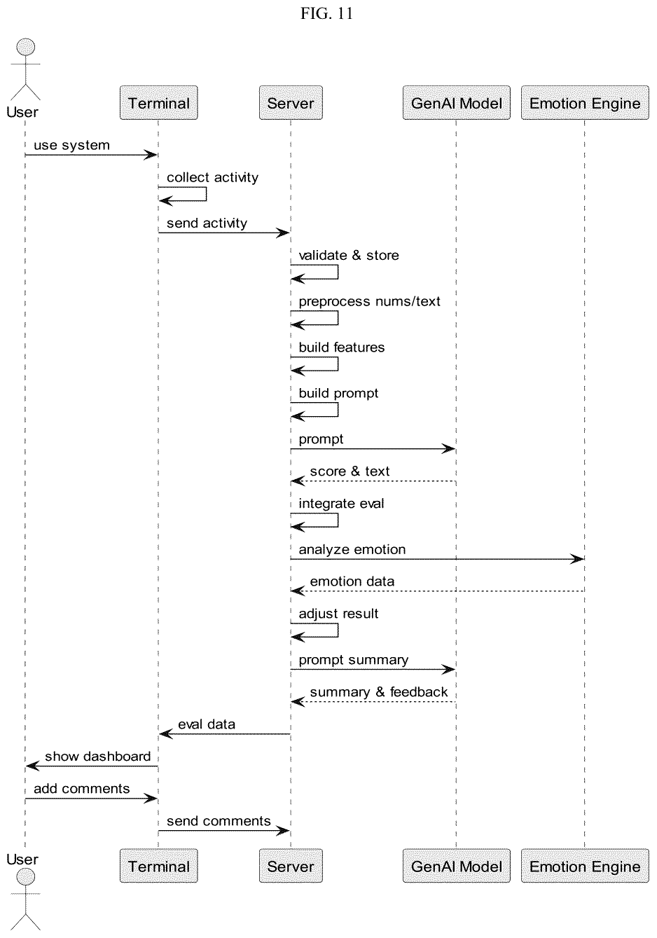

The following describes the processing flow using FIG. 11.

### Step 1:

The terminal collects daily activity data of a worker. The terminal monitors applications such as an email client, a communication tool, an online meeting application, and a work report input screen. The terminal records, as input, events such as “email sent,” “message posted,” “meeting joined,” and “report submitted,” together with timestamps, user identifiers, and content where applicable. The terminal aggregates these raw events into structured records, for example by counting the number of emails sent per day, summing meeting participation time per day, counting the number of posts in communication tools, and storing the full text of work reports. The output of this step is a set of structured activity records stored in a local memory or buffer on the terminal.

### Step 2:

The terminal transmits the structured activity records to the server. The terminal takes, as input, the buffered activity records and an authentication token for the worker. The terminal establishes a secure communication session with the server, for example using an encrypted transport protocol, and packages the activity records into one or more request messages with a predefined schema (e.g., JSON fields such as employee_id, date, email_count, meeting_duration, post_count, report_text). The terminal sends these request messages to a predefined network endpoint of the server. The output of this step is a stream of network requests containing the structured activity records delivered to the server.

### Step 3:

The server receives and validates the activity data sent from the terminal. The server takes, as input, the request messages arriving at the network endpoint. The server parses the message bodies, verifies the authentication token, checks mandatory fields, and validates that numerical values (e.g., counts, durations) are within allowed ranges and that text lengths do not exceed limits. The server discards invalid records or marks them with error flags. The server creates internal data objects that conform to its database schema. The output of this step is a set of validated activity records ready to be stored, each associated with a worker identifier and a time period.

### Step 4:

The server stores the validated activity records as structured data in a storage resource. The server takes, as input, the validated activity records produced in Step 3. The server maps fields in the records to columns in database tables, such as an “activity_header” table for basic identifiers and timestamp, an “email_metrics” table for email-related counts, a “meeting_metrics” table for meeting durations, a “communication_metrics” table for post counts, and a “report_texts” table for work report content. The server then executes database insert operations and creates indexes, for example on employee_id and date. The output of this step is a set of persistent database rows that store the raw structured activity data in relational form.

### Step 5:

The server preprocesses numerical activity metrics to generate feature vectors. The server takes, as input, the raw numerical fields stored in the metrics tables, for a specified evaluation period (for example, one day or one week). The server reads records, computes aggregated metrics such as total_email_count, total_meeting_hours, total_post_count, and report_length (e.g., character or token count), and then applies normalization functions. For example, the server subtracts a department mean and divides by a standard deviation or by a predefined scaling factor, thereby transforming raw counts into normalized feature values. The server concatenates these normalized values into feature vectors, such as [norm_email_count, norm_meeting_hours, norm_post_count, norm_report_length]. The output of this step is a set of numerical feature vectors stored in a feature table and/or held in memory for further processing.

### Step 6:

The server preprocesses textual report content to generate text embeddings. The server takes, as input, report_text fields associated with the worker and period of interest. The server applies a natural language processing module to tokenize the text, remove stop words, and convert tokens to token IDs. The server then feeds the sequence of tokens into a deep neural network encoder (for example, a transformer encoder implemented in a deep learning framework), which performs matrix multiplications, self-attention, and non-linear transformations to compute context-dependent token embeddings. The server aggregates these token embeddings, for example by mean pooling or by selecting the embedding associated with a special classification token, to produce a fixed-length text embedding vector. The output of this step is a set of dense numerical embedding vectors that represent the semantic content of the reports, stored in a report_embedding table or kept in memory.

### Step 7:

The server constructs unified AI input instances by combining numerical features and text embeddings. The server takes, as input, the numerical feature vectors from Step 5 and the text embedding vectors from Step 6, along with optional categorical attributes such as department or role. The server encodes categorical attributes as one-hot vectors or learned embedding vectors and concatenates them with the numerical features and text embeddings to form a unified input vector or tensor for each worker-period pair. The server aligns vectors by employee_id and date, ensuring that each unified instance corresponds to a consistent set of activity and report data. The output of this step is a collection of unified AI input instances, each represented as an array or tensor suitable for model input.

### Step 8:

The server evaluates worker performance with a discriminative neural network model. The server takes, as input, the unified AI input instances from Step 7. The server loads a trained performance evaluation network that includes layers for processing the combined numerical and text features. The server passes batched input instances through the network, which performs matrix multiplications, activation functions, and possibly attention mechanisms to derive intermediate hidden representations. The network outputs one or more performance scores, such as an overall performance score and sub-scores for communication, reporting quality, and collaboration, as continuous numeric values. The output of this step is a set of evaluation scores per worker and period, stored in an evaluation_score table and/or made available in memory.

### Step 9:

The server generates a prompt sentence for a generative AI model based on the evaluation context. The server takes, as input, the feature vectors, evaluation scores from Step 8, and selected excerpts from report_text. The server formats a natural-language prompt sentence that includes numeric values and text snippets in a predefined template. For example, the server may generate the following prompt sentence:

“Using the following employee activity data, evaluate the employee's performance and generate an overall performance assessment.

### Activity Data:

Number of emails sent today: 50
Online meeting participation time today: 3 hours
Communication tool posts: 20 messages on an internal communication platform
Work report content: ‘Completed the monthly sales analysis, coordinated with the marketing team, and prepared a detailed presentation for the client meeting.’

Please output: (1) a numerical performance score from 0 to 100, and (2) a concise textual explanation of the employee's performance.”

The server replaces the numeric values and text with those corresponding to the actual worker and period. The output of this step is a prompt sentence string that encodes the evaluation context for the generative AI model.

### Step 10:

The server obtains evaluation information from the generative AI model using the prompt sentence. The server takes, as input, the prompt sentence produced in Step 9. The server tokenizes the prompt sentence, converts tokens into embeddings, and feeds them into a transformer-based generative model running locally or accessed via a model inference service. The model processes the tokens through multiple self-attention and feed-forward layers and generates output tokens one by one, guided by learned parameters. The server decodes the output tokens into natural language text and, if specified in the prompt, parses any numeric score contained in the output. The server may apply a post-processing rule to extract a performance score (e.g., the first number between 0 and 100) and an explanatory paragraph. The output of this step is generative-model-based evaluation information, including a numeric score and a textual explanation.

### Step 11:

The server integrates multiple evaluation sources into an integrated evaluation result. The server takes, as input, the evaluation scores from the discriminative model (Step 8), the generative-model-based evaluation information (Step 10), value-based evaluation data stored in a value_evaluation table, and manager evaluation data stored in a manager_evaluation table. The server applies a weighting algorithm that multiplies each score by a predefined weight and sums the weighted scores to produce an integrated performance score. The server may also compute auxiliary metrics such as the variance of component scores and flags indicating inconsistencies. The server combines these numeric results with categorical labels such as “Excellent,” “Good,” or “Needs Improvement” based on threshold rules. The output of this step is an integrated evaluation result object per worker and period, stored in an integrated_evaluation table.

### Step 12:

The server analyzes emotion data and reflects the result in the integrated evaluation. The server takes, as input, emotion data related to the worker, such as self-reported mood indicators, text messages, or signals derived from interaction logs, stored in an emotion_data table. The server executes an emotion analysis component that transforms these inputs into emotion features (e.g., sentiment polarity scores, emotion categories). The server may use a classifier network that outputs probabilities for predefined emotion labels. The server then associates the emotion analysis results with the corresponding integrated evaluation result from Step 11. The server may adjust the integrated evaluation score slightly or attach flags or modifiers (e.g., “high stress state”) according to predetermined rules. The output of this step is an emotion-aware integrated evaluation result that includes both performance scores and emotion analysis metadata.

### Step 13:

The server generates evaluation summary text and feedback text based on the integrated evaluation and emotion analysis. The server takes, as input, the emotion-aware integrated evaluation result from Step 12, including numeric scores, component scores, emotion labels, and previous trends. The server constructs a second prompt sentence or a set of structured inputs for the generative AI model, specifying that the output should include a summary of strengths, areas for improvement, and tone adapted to the emotion state. The server then invokes the generative AI model to produce natural-language evaluation summary text and detailed feedback text. The server may enforce length and structure constraints, for example by adding instructions in the prompt to generate bullet points or separate sections. The output of this step is a pair of text fields: evaluation summary text and feedback text, stored in an output_text table and linked to the corresponding worker and period.

### Step 14:

The server prepares visualization data and transmits it to the terminal. The server takes, as input, the integrated evaluation scores, component scores, time-series data from previous periods, and the generated texts from Step 13. The server formats these data into a response structure suitable for graphical rendering, including arrays of scores over time, labels for evaluation factors, and strings for textual explanations. The server may compress or filter the data to minimize network usage. The server then sends the response to the terminal via a secure communication channel. The output of this step is a visualization-ready data payload delivered to the terminal.

### Step 15:

The terminal renders the evaluation information for the user. The terminal takes, as input, the visualization-ready data payload from the server. The terminal parses charts data and text data and uses a graphical user interface library to draw graphs such as line charts for time-series scores and bar charts for factor-wise scores. The terminal displays evaluation summary text and feedback text in designated panes, possibly highlighting key phrases or color-coding sections according to emotion categories or score thresholds. The terminal updates the display interactively when the user selects different workers or time periods. The output of this step is a set of visual elements shown on the terminal display that present the evaluation results to the user.

### Step 16:

The user reviews the displayed evaluation and optionally provides additional feedback. The user takes, as input, the visual elements rendered by the terminal, including graphs and texts. The user interprets the scores and explanations and may enter comments or adjustments through input fields on the terminal interface, such as additional notes or confirmations. The terminal captures these user inputs and sends them back to the server, where they can be stored as supplementary feedback data. The output of this step is optional user-generated feedback records that can be incorporated into future evaluations or used for auditing purposes.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional performance evaluation systems for workers and equipment typically rely on siloed data processing pipelines and manually designed scoring rules that are fixed, coarse, and difficult to adapt. In many implementations, business activity data such as communication logs, meeting participation, and reporting records are processed independently from equipment operation data such as operating time, processed unit counts, and error occurrences. As a result, such systems often fail to produce a unified, context-aware assessment that covers both human activities and machine operation in an integrated manner.

Furthermore, existing systems frequently use static rule-based logic or simple statistical models that are not capable of flexibly incorporating heterogeneous information sources, such as text-based reports, numerical sensor readings, and emotional states of users, into a single, coherent evaluation. Even when machine learning is used, the models are typically trained and deployed as closed components with limited ability to generate human-understandable explanations or tailored feedback. Consequently, human operators, such as managers and workers, are forced to interpret raw scores or charts on their own, which increases cognitive load and often leads to inconsistent decisions.

From a computer-technology perspective, there is also a limitation in how conventional systems orchestrate different AI components. Generative models, discriminative inference models, and emotion analysis engines are usually invoked in isolation, with ad hoc interfaces and without a systematic prompt design or data flow. This leads to inefficient use of computing resources, redundant data transformations, and difficulty in maintaining or extending the system. Moreover, current architectures lack a robust mechanism for dynamically constructing and managing prompt sentences for generative AI models in a way that tightly couples numerical evaluation results with natural-language feedback generation.

Another problem is that traditional visualization and reporting subsystems are often decoupled from the core evaluation pipeline, requiring separate configuration and manual report drafting. This separation reduces the responsiveness of the system and hinders real-time or near-real-time feedback loops. It also limits the system's ability to adjust the content and tone of feedback based on the emotional state of individual users, which is increasingly important in human-computer interaction and digital workplace environments.

Accordingly, there is a need for an improved computer-implemented system and method that: (i) unifies collection and preprocessing of business activity data and equipment operation data; (ii) integrates discriminative AI evaluation models, generative AI models, and emotion analysis engines through a structured prompt-based interface; (iii) automatically generates comprehensive, multi-source evaluation results; and (iv) produces context-aware, natural-language feedback and visual presentations in a computationally efficient and maintainable manner. Such an improvement in computer technology should provide a concrete architecture and processing flow that better manages heterogeneous data, reduces manual intervention, and enhances the quality and usability of performance evaluations through improved interaction between different AI components.

The specific processing by the specific processing unit 290 of the data processing device 12 in Application Example 1 is realized by the following means.

The present invention provides a server comprising a processor and a storage apparatus, the processor being configured to execute computer-executable instructions that cause the server to collect behavioral information indicating business activities of human subjects and operation information indicating operating states of equipment from multiple external apparatuses via a communication function, to store the collected behavioral information and operation information as recorded information in the storage apparatus, to perform preprocessing including information extraction processing, missing-value completion processing, normalization processing, and aggregation processing on the recorded information to generate evaluation input information, to generate and transmit prompt sentences to a generative AI model based on at least a portion of the evaluation input information and to automatically acquire first evaluation information regarding the business activities from the generative AI model, to input at least a portion of the evaluation input information relating to the operation information into a trained inference model that executes numerical computation processing and to calculate second evaluation information including efficiency information, reliability information, and failure prediction information regarding the equipment, to obtain value evaluation information and manager evaluation information and integrate the first evaluation information, the value evaluation information, and the manager evaluation information using an integration evaluation model in order to calculate comprehensive evaluation information and associate the comprehensive evaluation information with the second evaluation information to generate an overall evaluation result for each evaluation target, to input emotion-related information into an emotion analysis engine to obtain an emotion analysis result indicating an emotional state of a user and to perform correction processing that reflects the emotion analysis result in the comprehensive evaluation information, to generate additional prompt sentences based on at least the comprehensive evaluation information, the second evaluation information, and the emotion analysis result and to transmit the additional prompt sentences to the generative AI model so as to cause the generative AI model to generate feedback information expressed in natural language, to store the feedback information in association with corresponding evaluation targets, and to convert at least the comprehensive evaluation information and the feedback information into output information suitable for visual presentation and provide the output information to a display apparatus. This enables an integrated, computer-implemented evaluation pipeline that unifies heterogeneous behavioral and operation data, orchestrates discriminative and generative AI components through structured prompt sentences, dynamically adjusts evaluation results using emotion analysis, and automatically produces comprehensive, user-adapted visual and natural-language feedback, thereby improving the functionality, efficiency, and usability of performance evaluation in a computing environment.

The term “processor” refers to one or more hardware-based computing units, such as a central processing unit or a processing core, configured to execute computer-executable instructions to perform data collection, preprocessing, model inference, prompt generation, and feedback generation.

The term “storage apparatus” refers to one or more memory devices, such as semiconductor memory or magnetic storage, configured to store recorded information, evaluation input information, model outputs, prompt sentences, and feedback information.

The term “behavioral information” refers to data indicating business-related activities of human subjects, including communication activities, meeting participation, reporting activities, and other work-related actions represented as structured or unstructured data.

The term “operation information” refers to data indicating operating states of equipment, including operation time, processed unit counts, error occurrences, and other machine-related performance indicators collected from sensors or control systems.

The term “external apparatus” refers to any information processing device, communication device, conferencing device, workflow management device, or sensing device that provides behavioral information or operation information to the server via a communication function.

The term “communication function” refers to hardware and software components that enable data exchange between the server and external apparatuses over a wired or wireless communication network using a defined communication protocol.

The term “recorded information” refers to raw or preprocessed behavioral information and operation information that have been stored in the storage apparatus in association with identifiers, timestamps, or other attributes.

The term “preprocessing” refers to a set of data transformation operations including information extraction, missing-value completion, normalization, and aggregation applied to recorded information to generate evaluation input information suitable for subsequent analysis.

The term “information extraction processing” refers to operations that identify, select, or derive relevant attributes, entities, or numerical values from recorded information, including parsing, filtering, and feature derivation.

The term “missing-value completion processing” refers to operations that detect absent or undefined data elements in recorded information or intermediate data structures and assign replacement values using predetermined rules or statistical methods.

The term “normalization processing” refers to operations that scale or transform numerical values into a common range or distribution, such as by min-max scaling or standardization, to facilitate comparison and model processing.

The term “aggregation processing” refers to operations that combine multiple data records into summarized values over specified units, such as time intervals, evaluation targets, or categories, using statistical functions.

The term “evaluation input information” refers to structured data derived from recorded information through preprocessing, formatted as feature vectors or other representations suitable for input to inference models or generative AI models.

The term “generative AI model” refers to a model implemented by a computing system and configured to generate natural-language text or other content based on input text, prompt sentences, and optional structured data.

The term “prompt sentence” refers to a text-based instruction or query, optionally including structured data and constraints, that is provided as input to a generative AI model to control or guide the content and style of generated output.

The term “first evaluation information” refers to evaluation results regarding business activities of human subjects, generated by a generative AI model in response to a prompt sentence based on evaluation input information.

The term “trained inference model” refers to a predictive model, such as a machine learning or statistical model, trained on historical data and configured to perform numerical computation processing to output evaluation results from input features.

The term “numerical computation processing” refers to operations such as matrix multiplication, application of activation functions, and statistical calculations executed by a trained inference model to produce quantitative outputs.

The term “second evaluation information” refers to evaluation results regarding equipment, including efficiency information, reliability information, and failure prediction information, calculated by the trained inference model based on operation information.

The term “efficiency information” refers to data indicating performance efficiency of equipment, such as processed units per time period, utilization rates, or other productivity-related metrics.

The term “reliability information” refers to data indicating stability or dependability of equipment, such as error rates, failure frequencies, or uptime ratios.

The term “failure prediction information” refers to data indicating likelihood or risk of future equipment failure, derived from patterns in operation information and computed by the trained inference model.

The term “value evaluation information” refers to evaluation data indicating perceived or measured value of human subjects or equipment in relation to business objectives, obtained from an external evaluation source or system.

The term “manager evaluation information” refers to evaluation data indicating assessments made by supervisors or managers regarding performance or behavior of human subjects or equipment.

The term “integration evaluation model” refers to a model or algorithm configured to combine multiple evaluation inputs, including first evaluation information, value evaluation information, and manager evaluation information, to produce comprehensive evaluation information.

The term “comprehensive evaluation information” refers to integrated evaluation data representing an overall assessment of an evaluation target, obtained by combining multiple types of evaluation inputs using the integration evaluation model.

The term “evaluation target” refers to an entity subject to evaluation, including an individual worker, a group of workers, a single piece of equipment, or a group of equipment.

The term “emotion-related information” refers to data used to infer a user's emotional state, including text messages, interaction patterns, physiological signals, or other observable indicators processed by an emotion analysis engine.

The term “emotion analysis engine” refers to a software or hardware module configured to analyze emotion-related information and output an emotion analysis result indicating an emotional state.

The term “emotion analysis result” refers to data representing an estimated emotional state of a user, such as stress level, satisfaction, or sentiment, produced by the emotion analysis engine.

The term “correction processing” refers to operations that modify, weight, or adjust comprehensive evaluation information or related outputs based on an emotion analysis result.

The term “feedback information” refers to natural-language text or other content that includes explanations, improvement points, and strengths regarding an evaluation target, generated at least in part by a generative AI model.

The term “output information” refers to data formatted for presentation to a user, including comprehensive evaluation information, second evaluation information, and feedback information, converted into a representation suitable for display.

The term “display apparatus” refers to any device capable of presenting visual information to a user, such as a monitor, terminal, or portable display device.

The term “visual information in a chart format” refers to graphical representations, such as line graphs, bar graphs, or radar charts, that display aggregated evaluation data over time or across evaluation targets.

The term “structured information” refers to data organized according to a predefined schema or structure, such as key-value pairs, tables, or hierarchical formats, that represent evaluation results and analysis outputs.

The term “constraint conditions” refers to explicit requirements or instructions included in a prompt sentence that specify desired properties of generated content, such as inclusion of improvement points, strengths, or language style constraints.

The term “workers” refers to human subjects performing business activities within an organization and subject to performance evaluation by the system.

The term “equipment” refers to physical devices, machinery, or systems used in production, processing, or other operational activities, whose performance is evaluated by the system.

In one embodiment, a server implements the claimed system using a hardware configuration that includes at least one central processing unit, a main memory, a non-volatile storage apparatus, and a network interface. The server executes an operating system such as a general-purpose server operating system and runs application software built, for example, in a programming language such as Python and using software libraries such as Pandas for data manipulation, a machine learning framework such as TensorFlow for inference models, and a web framework such as a general-purpose HTTP application framework for communication with terminals. The server communicates with terminals, which may be personal computers, tablet devices, or smartphones, via wired or wireless networks. A terminal executes a web browser or dedicated client software to display evaluation results and feedback generated by the server. A user operates the terminal to review evaluation results, read feedback, and input additional instructions or prompt sentences for a generative AI model.

The server acquires behavioral information and operation information from multiple external apparatuses. For example, the server acquires behavioral information related to workers from an information exchange apparatus such as a message-based collaboration system, from a conferencing apparatus such as an online meeting system, and from a report management apparatus such as an electronic reporting system. In addition, the server acquires operation information from a detection apparatus such as a sensor unit attached to factory equipment or an industrial controller. These external apparatuses transmit data to the server via a communication function using protocols such as HTTPS, a message-queue protocol, or an industrial protocol. The server stores the received data as recorded information in the storage apparatus, typically in relational database tables and time-series tables managed by a database management system.

The server represents the recorded information using specific data structures that enable efficient preprocessing and model inference. For example, the server creates, in main memory, a table-like structure for workers, in which each row stores features associated with a worker and a time window such as a day, and each column stores primitive attributes such as number of messages sent, number of received messages, number of meetings attended, total meeting duration, number of reports submitted, and so on. For equipment, the server creates a structure in which each row corresponds to a piece of equipment and a time window, with columns for operation time, number of processed units, number of errors, and derived metrics such as mean time between errors. The server uses a data manipulation library such as Pandas to construct and manipulate these structures as data frames, enabling vectorized operations and efficient memory management.

The server performs preprocessing on the recorded information to generate evaluation input information. The server executes information extraction processing by parsing raw text fields and metadata to derive numerical features. For instance, the server parses subject lines and content of reports to detect certain keywords or categories and encodes them as counts. The server executes missing-value completion processing by applying algorithms such as forward filling, median substitution, or model-based imputation. For example, if operation time for a machine is missing in a given time window, the server estimates it based on neighboring windows or historical patterns stored in the database. The server performs normalization processing such as min-max scaling or z-score standardization so that each feature lies in a defined numeric range, which improves numerical stability of subsequent model computations. The server performs aggregation processing by grouping records by worker ID and date or by machine ID and date and computing aggregates such as sums, averages, and variances. By structuring data in this way, the server reduces memory footprint and improves cache efficiency, which results in faster processing compared to naive per-record processing.

The server stores the preprocessed data as evaluation input information. In one implementation, the server converts data frames into dense numeric tensors, where each tensor has a fixed dimension corresponding to the number of features used in the models. These tensors are fed directly to a trained inference model implemented in TensorFlow. The inference model for equipment performance can be, for example, a feedforward neural network having an input layer, several hidden layers with activation functions such as rectified linear units, and an output layer that produces probability-like values or regression outputs for efficiency information, reliability information, and failure prediction information. The server loads the model parameters, which have been pre-trained using historical labeled data stored in the storage apparatus, from a model file. The server executes numerical computation processing on a central processing unit or a graphics processing unit, using tensor operations provided by the TensorFlow runtime.

The server trains the inference model offline by using a supervised learning method. During training, the server reads historical operation information and associated ground-truth labels such as actual failure events, actual throughput, and maintenance logs. The server defines a loss function, for example, a weighted sum of mean squared error for regression outputs and cross-entropy for classification outputs. The server applies an optimization algorithm such as stochastic gradient descent or Adam to update model parameters. The server computes gradients of the loss function with respect to model weights by backpropagation, and iteratively updates the weights to minimize the loss on the training set while monitoring a validation set to prevent overfitting. The server may also apply data augmentation methods, such as adding small random perturbations to numeric inputs or random resampling of time windows, to improve robustness. These training operations enable the server to obtain an inference model that generalizes on unseen operation information and provides accurate second evaluation information.

The server evaluates business activities by using a generative AI model and structured prompt sentences. The server may use a generative AI model implemented as a transformer-based neural network with an encoder-decoder or decoder-only architecture pre-trained on large text corpora. The server does not only send raw text but constructs a prompt sentence that embeds evaluation input information in a structured and constrained format. For example, the server may construct a prompt sentence such as:

“The server has collected the following daily activity metrics for Worker A: messages_sent=45, messages_received=60, meetings_attended=3, total_meeting_minutes=120, reports_submitted=1. Based on these metrics, generate a concise performance evaluation focusing on communication balance, meeting load, and reporting thoroughness. Provide a numerical score from 0 to 100 and a short explanation.”

The server embeds feature values into the prompt sentence in a deterministic order and with fixed labels so that the generative AI model can consistently interpret the information. The server then transmits this prompt sentence to the generative AI model via a standardized interface, such as an HTTP-based application programming interface. The generative AI model, running on the same server or on a remote computation node, produces natural-language text and possibly structured outputs such as numerical scores embedded in the text. The server parses the generated text, extracts numerical parts according to predefined patterns, and stores them as first evaluation information in the storage apparatus.

The server obtains value evaluation information and manager evaluation information from external sources such as human resource systems or manual inputs provided by managers through terminals. The server combines the first evaluation information, the value evaluation information, and the manager evaluation information in an integration evaluation model. In one embodiment, the integration evaluation model is implemented as a multi-layer neural network that accepts concatenated feature vectors composed of the three evaluation sources and additional context, such as worker role or department. The model is trained using historical data where composite evaluation outcomes are known, and it may use a loss function such as mean absolute error or a ranking-based loss when the target is a relative ordering of workers. By using such a model instead of simple weighted averages, the server can capture non-linear relationships between different evaluation sources and better reflect complex evaluation policies.

The server further processes emotion-related information by using an emotion analysis engine. For example, the server acquires text messages, survey responses, or vocal cues from external apparatuses. The server converts these inputs into feature vectors by using natural-language processing techniques such as tokenization, embedding using pre-trained word vectors or contextual embedding models, and acoustic feature extraction for audio signals. The emotion analysis engine, which may also use a neural network architecture such as a recurrent neural network or transformer, outputs an emotion analysis result indicating levels of stress, satisfaction, or engagement. The server uses this emotion analysis result to perform correction processing on the comprehensive evaluation information. For instance, when the emotion analysis result indicates high stress with concurrent high workload and high performance, the server may adjust the feedback content to emphasize well-being and workload management without reducing objective performance scores.

The server generates additional prompt sentences to obtain natural-language feedback information from a generative AI model. In one embodiment, the server creates a prompt sentence that includes both structured evaluation data and textual instructions for the generative AI model. An example is:

“Here is the performance summary for Worker A over the last month: comprehensive_score=82, communication_score=78, equipment_efficiency_score for assigned machines=0.92, predicted_failure_risk for those machines=low, emotion_state=moderate_stress. Generate feedback in English that explains these results in simple terms, highlights three strengths, and suggests two concrete improvement actions. Use a polite and professional tone.”

By embedding numerical and categorical data within such a prompt sentence, the server guides the generative AI model to generate feedback that is consistent with quantitative results. The server analyzes the output text for structural elements, such as bullet-like patterns or keyword markers, to separate strengths and improvement points. The server stores this feedback information in association with the corresponding evaluation target in the storage apparatus.

The server also prepares output information suitable for visualization on terminals. The server converts comprehensive evaluation information and second evaluation information into aggregated datasets grouped by time and evaluation targets. The server generates visual information such as line graphs indicating efficiency over time, bar graphs comparing reliability across multiple machines, and radar charts showing balanced or unbalanced aspects of worker performance. The server exposes these visual data structures through an application programming interface, and the terminal retrieves them and renders them using a graphics library executed in a browser environment. This architecture allows the heavy computations such as neural network inference and aggregation over large datasets to be centralized on the server, while terminals focus on rendering and interaction.

The described arrangement produces specific technical effects that improve computer technology. By using structured tensors and data frames, the server reduces redundant data conversions and achieves higher cache locality, which results in faster preprocessing and inference. By integrating discriminative inference models and generative AI models through prompt sentences, the server eliminates the need for multiple separate reporting scripts and manual drafting, reducing communication overhead between modules and enabling consistent generation of feedback. The use of neural network-based integration evaluation models instead of static rules improves accuracy of composite scores as the models adapt to patterns in historical data. Furthermore, the emotion analysis engine's output enables the server to adjust feedback without recalculating core performance scores, separating the computational layers and improving modularity and maintenance.

The server's use of specialized loss functions, optimization algorithms, and data augmentation during training results in more robust inference models that maintain accuracy even under varying data distributions, thereby reducing error rates in failure prediction or performance classification. The system's ability to handle heterogeneous data—numerical sensor readings, text-based reports, metadata, and emotion-related signals—within a unified architecture contributes to improved data management and consistent evaluation. Because the preprocessing and inference pipelines are explicitly designed to work with fixed-format feature vectors and deterministic prompt construction, the system avoids ambiguities and misinterpretations that can occur when models are used in an ad hoc fashion.

In one alternative embodiment, the server implements the inference models as gradient-boosted decision trees instead of neural networks for certain types of structured numerical data, and reserves neural networks for tasks requiring deep representation learning such as emotion analysis and natural-language generation. In another variation, the server deploys multiple generative AI models specialized for different languages or domains and selects a model based on metadata such as user locale or industry type, embedding this selection logic in the prompt-generation module. In yet another embodiment, the server uses on-premises inference engines instead of remote generative AI services, thereby reducing communication latency and increasing confidentiality for sensitive evaluation data.

In each embodiment, the server, terminal, and user interact in a way that maintains the core technical contributions: structured data representations, explicit preprocessing steps, defined inference model architectures, and prompt-based integration of generative and discriminative AI models. These features collectively enable more accurate, faster, and more maintainable performance evaluation processing than conventional systems that rely on manual interpretation, isolated models, or unstructured data flows.

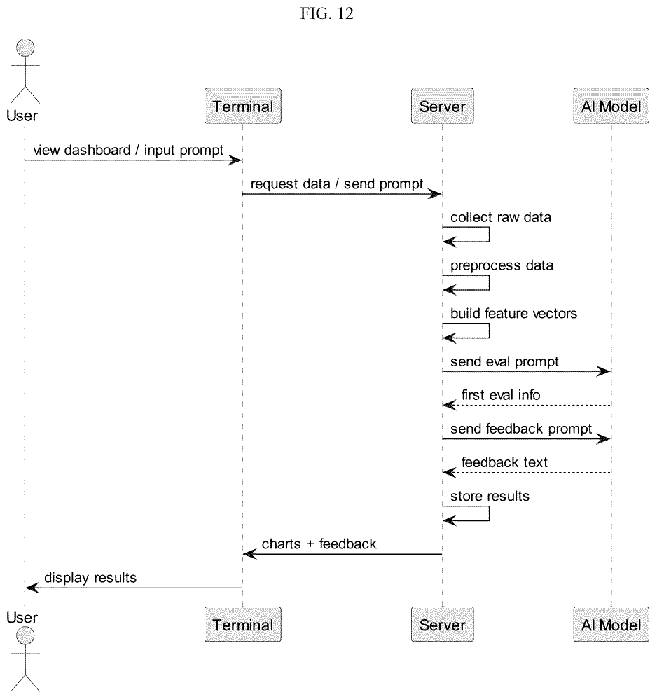

The following describes the processing flow using FIG. 12.

### Step 1:

Server acquires raw behavioral information and operation information.

Server receives, as input, data streams from external apparatuses, including communication logs from an information exchange apparatus, meeting logs from a conferencing apparatus, report records from a report management apparatus, and sensor readings from a detection apparatus attached to equipment.

Server parses incoming messages, attaches timestamps and identifiers such as worker IDs and equipment IDs, and stores each record in corresponding tables of a database in the storage apparatus.

Server outputs stored raw records, organized into at least a worker-activity table and an equipment-operation table.

### Step 2:

Server constructs structured data frames for workers and equipment.

Server reads, as input, the worker-activity table and the equipment-operation table from the database.

Server uses a data manipulation library to group records by worker ID and time window for workers, and by equipment ID and time window for equipment, and then aggregates primitive attributes such as counts and durations into numerical features.

Server outputs a worker feature data frame and an equipment feature data frame, where each row corresponds to an evaluation target and each column corresponds to a feature.

### Step 3:

Server performs missing-value completion and normalization.

Server receives, as input, the worker feature data frame and the equipment feature data frame.

Server scans each column to detect missing entries and applies algorithms such as forward fill or median substitution to replace missing values, then computes statistics such as mean and standard deviation per feature and applies normalization formulas to scale feature values into a defined numeric range.

Server outputs cleaned and normalized worker feature vectors and equipment feature vectors suitable for model input.

### Step 4:

Server generates first prompt sentences for business activity evaluation.

Server takes, as input, the normalized worker feature vectors and associated metadata such as worker IDs and dates.

Server formats each feature vector into a textual template, for example inserting feature names and numeric values into a fixed sentence structure, and appends evaluation instructions specifying requested score ranges and explanation requirements.

Server outputs first prompt sentences, each associated with a specific worker and time period, ready to be transmitted to a generative AI model.

### Step 5:

Server transmits first prompt sentences to a generative AI model and acquires first evaluation information.

Server receives, as input, a set of first prompt sentences.

Server sends each prompt sentence over a network interface to a generative AI model endpoint, waits for responses, and then parses returned natural-language text to extract numerical scores and categorical labels based on predefined patterns such as “Score: XX/100” or key phrases.

Server outputs first evaluation information that includes, for each worker and time window, at least one numerical evaluation value and optional explanation text.

### Step 6:

Server executes an inference model for equipment performance evaluation.

Server takes, as input, the normalized equipment feature vectors.

Server loads a trained inference model, converts each feature vector into a numeric tensor, and runs forward propagation through the model layers, performing matrix multiplications, activation functions, and normalization steps to compute outputs representing efficiency, reliability, and failure risk.

Server outputs second evaluation information, which includes, for each piece of equipment and time window, efficiency information, reliability information, and failure prediction information.

### Step 7:

Server obtains value evaluation information and manager evaluation information and constructs integration inputs.

Server receives, as input, value evaluations from an external evaluation source and manager evaluations entered via terminals by users such as supervisors.

Server joins these evaluation values with the first evaluation information for each worker using worker IDs and evaluation periods, and concatenates the three types of scores into composite feature vectors.

Server outputs integrated evaluation input vectors that represent combined first, value, and manager evaluations per worker.

### Step 8:

Server computes comprehensive evaluation information using an integration evaluation model.

Server takes, as input, the integrated evaluation input vectors.

Server applies an integration evaluation model, which may be a trained neural network or a statistical combination algorithm, to each input vector, performing numerical operations such as weighted sums, non-linear transformations, and normalization to compute an overall comprehensive score.

Server outputs comprehensive evaluation information, including a composite score for each worker and associated intermediate metrics if configured.

### Step 9:

Server analyzes emotion-related information and generates emotion analysis results.

Server receives, as input, emotion-related information such as text messages, responses to surveys, or other user interaction logs.

Server pre-processes the input by tokenizing text, converting tokens to embeddings, and possibly extracting temporal features, and then passes these features to an emotion analysis engine that computes probabilities or scores for emotion categories such as stress and satisfaction.

Server outputs emotion analysis results, which may include emotion labels and numeric intensity values for each user and time period.

### Step 10:

Server applies correction processing based on emotion analysis results.

Server takes, as input, the comprehensive evaluation information and the emotion analysis results.

Server executes an adjustment algorithm that modifies or annotates comprehensive scores according to emotion levels, for example by applying scaling factors or adding flags when stress exceeds a threshold, without altering underlying raw performance indicators.

Server outputs corrected comprehensive evaluation information, which includes both original scores and adjusted or annotated versions reflecting emotional context.

### Step 11:

Server generates second prompt sentences for detailed feedback creation.

Server receives, as input, the corrected comprehensive evaluation information, the second evaluation information for equipment, and the emotion analysis results.

Server constructs, for each evaluation target, a second prompt sentence that embeds key numerical values and categories inside a textual instruction, specifying that the generative AI model should generate feedback that explains scores, highlights strengths, and proposes improvement actions in a specific tone or style.

Server outputs second prompt sentences mapped to workers and equipment.

### Step 12:

Server sends second prompt sentences to the generative AI model and obtains feedback information.

Server takes, as input, the set of second prompt sentences.

Server transmits each prompt sentence to the generative AI model, receives generated natural-language feedback, and optionally segments the feedback into sections such as “Strengths,” “Improvements,” and “Summary” by searching for headings or markers.

Server outputs feedback information objects that contain the full feedback text and metadata linking each feedback to a corresponding worker or equipment entry.

### Step 13:

Server stores evaluation and feedback results in the storage apparatus.

Server receives, as input, the first evaluation information, the second evaluation information, the corrected comprehensive evaluation information, the emotion analysis results, and the feedback information.

Server writes these data into dedicated tables in the database, creating or updating records keyed by evaluation target IDs and time periods, and ensuring referential integrity between different tables via foreign keys or identifiers.

Server outputs persistent records that can be queried later for visualization, reporting, or further analysis.

### Step 14:

Server prepares visualization data for terminals.

Server takes, as input, the stored evaluation and feedback records.

Server runs aggregation queries to compute time-series metrics, comparisons between workers or equipment, and distributions of scores, and then formats the results into compact structures such as arrays of timestamp-value pairs or category-value pairs suitable for rendering charts.

Server outputs visualization data sets, each annotated with type information such as line chart, bar chart, or radar chart.

### Step 15:

Terminal retrieves visualization data and renders graphical views.

Terminal receives, as input, visualization data sets from the server over a network connection.

Terminal parses the data and passes them to a graphics rendering component such as a charting library, which draws axes, plots points or bars, and applies styles such as colors and legends to distinguish different evaluation targets.

Terminal outputs on its display a set of interactive dashboards that show performance trends, comparisons, and summaries to the user.

### Step 16:

User interacts with the system and optionally inputs custom prompt sentences.

User views, as input, the dashboards and feedback texts on the terminal display.

User analyzes the presented information and, if additional clarification or scenario-based advice is desired, types a custom prompt sentence such as “Given the current efficiency and failure risk scores of my equipment group, suggest three scheduling strategies to minimize downtime over the next month.” into an input field.

User outputs the custom prompt sentence to the server by submitting the input through the terminal interface.

### Step 17:

Server processes custom prompt sentences and returns generative responses.

Server receives, as input, custom prompt sentences from terminals along with identifiers of the requesting user and context such as selected workers or equipment.

Server augments each prompt with relevant evaluation data fetched from the database, concatenates the data and the user's instruction into a combined prompt sentence, sends the combined prompt sentence to the generative AI model, and then returns the generated response text to the terminal.

Server outputs context-aware natural-language responses that the terminal displays to the user for further decision-making.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional performance evaluation systems in business environments typically rely on static rule-based scoring, manually designed indicators, or simple statistical aggregation. Such systems face several technical problems when implemented on general-purpose computer systems.

First, conventional systems are not architected to flexibly integrate heterogeneous data streams, such as raw work activity logs, administrator evaluations, value evaluations, and emotion-related information, into a unified processing pipeline. As a result, processing logic is fragmented across multiple software modules, and servers repeatedly perform redundant data transformations, which increase computation load, memory usage, and latency on the processor.

Second, many existing systems do not provide a machine-understandable representation of evaluation metrics that is directly consumable by visualization components executing on external client devices. Servers often output ad hoc or non-structured data formats, requiring each client application to perform its own conversion and aggregation. This causes duplicated processing on terminals, inconsistent visualization results, and increased network traffic due to inefficient data representations.

Third, while generative AI models can generate code or evaluation logic based on natural language instructions, conventional performance evaluation architectures do not expose a systematic mechanism to use prompt sentences to reconfigure or evolve the server-side processing pipeline. As a result, when evaluation requirements change, human developers must manually modify and deploy backend programs. This leads to downtime, configuration errors, and inability to promptly adapt server behavior to new performance indicators or data sources.

Fourth, conventional systems rarely exploit emotion analysis results as a first-class input to the computational evaluation pipeline. Emotion-related information, if used at all, is often processed separately and is not consistently reflected in a comprehensive evaluation index. This results in under-utilization of available data and prevents the processor from generating technically richer composite indicators that better represent multifaceted user states while still being efficiently computable and transferable as structured data.

Fifth, front-end visualization functions are typically developed as independent components that tightly couple data acquisition, transformation, and rendering on the client side. Without a server-oriented structured information format specifically designed for visualization, terminals must perform significant local preprocessing before drawing charts, which increases CPU and memory consumption on client devices and leads to inconsistent behavior across different platforms.

Therefore, there is a need for a system architecture and a server-side processing method that: (i) unifies retrieval and transformation of work activity information into standardized evaluation index data; (ii) integrates generative AI model outputs, administrator evaluations, value evaluations, and emotion analysis into a comprehensive evaluation index in a computationally consistent manner; (iii) outputs such indices in a structured information format optimized for external visualization; and (iv) uses prompt sentences for a generative AI model to generate or update the server-side program that executes this entire pipeline, thereby improving flexibility, maintainability, and runtime efficiency of the computer system as a whole.

The specific processing by the specific processing unit 290 of the data processing device 12 in Example 2 is realized by the following means.

The present invention provides a server comprising a processor configured to acquire work activity information from a storage resource based on acquisition conditions including identification information and a time range; to generate evaluation index data including at least a delivery deadline adherence index and a collaboration contribution index by applying data structure conversion processing and statistical calculation processing to the acquired work activity information; to execute an automatic evaluation process by supplying the evaluation index data and a prompt sentence to a generative model and by generating a comprehensive evaluation index through integration of an evaluation result of the generative model, a value evaluation, and an administrator evaluation; to analyze emotion-related information by using an emotion analysis function and to reflect an analysis result in the comprehensive evaluation index; to convert the comprehensive evaluation index and the evaluation index data into a structured information format suitable for consumption by an external information processing device and to output the structured information format through an information providing interface; and to generate or update a program, in response to a prompt sentence input to the generative model, that when executed causes the server to perform a work activity information acquisition process, an evaluation index data generation process, the automatic evaluation process, and an output process of the structured information format. This enables a computer-centered evaluation system to technically improve processing efficiency and adaptability by centralizing metric computation and integration on the server, by producing visualization-ready structured data that reduces client-side preprocessing, and by allowing the overall evaluation pipeline to be programmatically reconfigured through prompt-driven interaction with a generative model, thereby enhancing scalability, maintainability, and responsiveness of the underlying computing infrastructure.

The term “processor” refers to a hardware-based or virtual computation resource, including a central processing unit, a graphics processing unit, or an execution core of a computing system, that executes machine instructions to perform data acquisition, data transformation, model inference, and control logic in the system.

The term “work activity information” refers to data representing operations performed by a worker or an entity in connection with tasks, projects, or services, including at least task identifiers, planned deadlines, completion times, statuses, and collaboration-related records.

The term “information storage unit” refers to a data retention resource, such as a database system, a file system, or a non-volatile memory device, that stores work activity information and related data in a machine-readable format.

The term “acquisition conditions” refers to parameter information, including at least identification information and a time range, that specifies a subset of work activity information to be retrieved from the information storage unit.

The term “identification information” refers to data that uniquely or distinctively identifies a worker, a group, a project, or another evaluation target, and that is used to filter or associate work activity information.

The term “time range” refers to a continuous or discrete interval on a time axis, specified by a start point, an end point, or recurrence rules, within which work activity information is to be acquired or aggregated.

The term “evaluation index data” refers to structured numerical or categorical data derived from work activity information through computation, representing one or more performance indicators used for evaluation.

The term “delivery deadline adherence index” refers to an evaluation indicator included in the evaluation index data that quantitatively represents a degree to which tasks or deliverables are completed on or before their planned deadlines during a time range.

The term “collaboration contribution index” refers to an evaluation indicator included in the evaluation index data that quantitatively represents a degree of cooperative behavior or support activities, such as reviews, assistance, or shared work, performed by a worker or an entity.

The term “data structure conversion function” refers to processing logic executed by the processor to transform raw work activity information into a target data structure, including operations such as normalization, aggregation, formatting, or schema mapping.

The term “statistical calculation function” refers to processing logic executed by the processor to compute statistical values, such as counts, ratios, averages, or normalized scores, based on work activity information or intermediate data.

The term “automatic evaluation process” refers to a sequence of operations executed by the processor that computes one or more evaluation results without manual scoring, using at least evaluation index data and a generative model.

The term “generative model” refers to a machine learning model or information processing model capable of generating outputs such as evaluation results, textual information, or program code in response to input data and prompt sentences.

The term “prompt sentence” refers to natural language or structured text data supplied to a generative model to specify an evaluation condition, a processing behavior, or a program generation requirement.

The term “evaluation result of the generative model” refers to output information produced by the generative model in response to evaluation index data and a prompt sentence, including at least a score, rating, or structured assessment associated with work performance.

The term “value evaluation” refers to evaluation information indicating a degree of consistency of work activity or outcomes with organizational values, policies, or qualitative criteria, provided as numerical or symbolic data.

The term “administrator evaluation” refers to evaluation information generated by a supervisory entity, such as a manager or evaluator, based on observation, review, or assessment of work outcomes, and represented in a machine-readable form.

The term “comprehensive evaluation index” refers to an integrated evaluation result produced by combining at least the evaluation result of the generative model, the value evaluation, the administrator evaluation, and optionally emotion-related information analysis, into a single or multi-dimensional indicator.

The term “emotion-related information” refers to data representing emotional states or affective responses of a user or worker, obtained from sources such as interaction logs, biometric signals, text messages, or questionnaire responses.

The term “emotion analysis function” refers to processing logic, implemented by an algorithm or model, that analyzes emotion-related information to estimate emotional attributes such as sentiment, stress level, engagement, or mood.

The term “analysis result” refers to data output from the emotion analysis function representing inferred emotional attributes, and used as input to generation or adjustment of the comprehensive evaluation index.

The term “structured information format” refers to a machine-readable data representation with an explicit schema, such as a hierarchical or tabular structure, that is suitable for transmission over a communication interface and direct consumption by visualization or processing components.

The term “information providing interface” refers to a communication endpoint or application programming interface through which the processor outputs the structured information format so that an external information processing device can access and retrieve the data.

The term “external information processing device” refers to a computing device or client system separate from the server that receives the structured information format and performs additional processing, such as visualization or user interaction.

The term “program” refers to a set of machine-executable instructions, scripts, or configuration data that, when executed by the processor, cause the processor to perform processes including acquisition of work activity information, generation of evaluation index data, automatic evaluation, and output in the structured information format.

The term “generate or update a program” refers to the operation of creating new program content or modifying existing program content, based at least on an output of the generative model in response to a prompt sentence, in order to change or refine the behavior of the server.

The term “information display function” refers to processing logic executed on the external information processing device that converts the structured information format into human-perceivable output, including graphical or textual representations.

The term “graph display” refers to a visual representation of numerical or categorical data using graphical elements such as bars, lines, or points, arranged in a coordinate system.

The term “chart display” refers to a visual representation of data using diagrammatic forms such as pie charts, radar charts, or other schematic formats distinct from basic text tables.

The term “time-series display” refers to a visual representation that arranges values of an index along a temporal axis to illustrate changes or trends over time.

The term “explanation information” refers to machine-generated descriptive data that indicates at least improvement issues and strengths of a worker or entity, based on the comprehensive evaluation index, analysis results, and evaluation index data.

The term “improvement issues” refers to aspects of performance or behavior that are identified as needing enhancement or correction according to the comprehensive evaluation index and related data.

The term “strengths” refers to aspects of performance or behavior that are identified as favorable, effective, or superior according to the comprehensive evaluation index and related data.

The term “worker” refers to an individual or entity that performs tasks or activities subject to evaluation within an organization or operational environment.

The term “administrator” refers to a supervisory or managerial entity that oversees workers, configures evaluation parameters, or receives explanation information for decision-making.

In one embodiment, a server, a terminal, and a user cooperate to implement the invention as follows.

The server includes at least one processor, a main memory, a non-volatile storage device, and a network interface. The server executes an operating system such as a general-purpose server operating system, and executes middleware including a web application framework, a database management system, and a machine learning runtime environment. The server deploys a backend application implemented, for example, in a programming language such as Python running on a general-purpose central processing unit. The backend application includes software modules for data acquisition, data structure conversion, statistical calculation, evaluation index generation, model inference, emotion analysis, structured data formatting, and program generation or update using a generative AI model.

The server stores work activity information and related evaluation data in a storage resource, such as a relational database or a distributed data store. The server defines tables or data collections with fields including generic identifiers (for example, worker identifier, group identifier, project identifier), temporal information (for example, task creation time, planned deadline, completion time), categorical status flags (for example, completion status, approval status), quantitative attributes (for example, task duration, number of review actions, number of collaboration events), and evaluation-related entries (for example, numerical administrator rating, numerical value alignment score). The server also stores emotion-related information, such as sentiment scores derived from text communication, time-series physiological signals, or interaction logs, in separate but linkable data structures.

The server acquires work activity information from the storage resource based on acquisition conditions including identification information and a time range. The server uses a data access layer that issues database queries expressed in a structured query language or equivalent, and retrieves result sets into an in-memory tabular data structure such as a two-dimensional array or a data frame. The server then applies a data structure conversion function that normalizes heterogeneous raw records into a unified schema. For example, the server converts timestamps to a standard time zone and data type, encodes categorical values as numeric codes, and reindexes records by worker identifier and time bucket.

The server uses a statistical calculation function to generate evaluation index data. The server calculates, for each worker and time range, a delivery deadline adherence index by computing the ratio of a count of tasks with completion time less than or equal to planned deadline to a total count of tasks within the time range. The server calculates a collaboration contribution index by aggregating normalized counts of collaboration-related events, such as peer review actions, cross-team support events, and shared artifact contributions. The server may perform normalization by dividing raw counts by a baseline factor (for example, average number of events across a population or a maximum observed value) and then applying a scaling function to map values into a standardized range such as 0 to 1.

The server constructs evaluation index data as a structured array of feature vectors, where each feature vector corresponds to a worker and contains at least the delivery deadline adherence index, the collaboration contribution index, and additional indicators such as task completion volume, defect rate, or rework frequency. The server stores the evaluation index data in an intermediate in-memory data structure optimized for efficient model inference, such as a dense matrix of floating-point values aligned in contiguous memory. By pre-computing and caching evaluation index data in this format, the server reduces repeated conversion overhead and improves cache locality, thereby reducing latency and processor load during subsequent evaluation processes.

The server executes an automatic evaluation process using a generative AI model. In one embodiment, the server implements the generative AI model as a neural network-based language model with an encoder-decoder architecture. The server represents each feature vector of evaluation index data as a textual or serialized prompt input for the model, or as an auxiliary vector input concatenated to a token embedding sequence. The server constructs a prompt sentence that instructs the model to produce evaluation output, such as:

“Evaluate the worker's performance based on the following metrics: on-time delivery rate, collaboration contribution index, task completion volume, and defect rate. Output a normalized overall performance score between 0 and 100 and a brief structured explanation.”

The server passes both the prompt sentence and a representation of the evaluation index data to the generative AI model. The generative AI model includes multiple layers of attention-based computation, where the server computes token embeddings, attention weights, and layer outputs according to learned parameter matrices. The server uses a forward propagation algorithm to calculate, token by token, a probability distribution over output tokens, and decodes this distribution into a textual evaluation result. The server may parse output tokens into structured fields representing an evaluation result of the generative model, such as an overall score, sub-scores for efficiency, quality, and collaboration, and a short textual rationale.

The server integrates the evaluation result of the generative AI model with value evaluation and administrator evaluation to generate a comprehensive evaluation index. The server uses an integration algorithm that combines scores using a weighted combination rule, for example by defining weight parameters for each evaluation source and computing a weighted sum, or by applying a secondary model such as a gradient-boosted decision tree. The server may store the weights in configuration data that can be updated independently of program code, and may calibrate the weights by minimizing a loss function against historical ground truth data. By systematically combining multiple evaluation sources at the server level, the server reduces inconsistencies that would occur if client applications independently combined scores.

The server analyzes emotion-related information by applying an emotion analysis function. In one embodiment, the server uses a neural network model with recurrent layers or attention layers trained to infer emotional attributes such as positive sentiment, negative sentiment, stress level, or engagement level from time-series signals or text features. The server extracts low-level features (for example, statistical moments of physiological signals, or term-frequency vectors for text) and feeds these features into the emotion analysis model. The server computes an analysis result as a vector of numeric emotion scores and stores it alongside the evaluation index data. The server modifies the comprehensive evaluation index according to predetermined rules, such as damping or amplifying certain components when sustained high stress or low engagement is detected, thereby reflecting emotion-related information in the final evaluation.

The server converts the comprehensive evaluation index and the evaluation index data into a structured information format for output. The server defines a hierarchical schema comprising top-level identifiers (for example, worker identifier, time range), mid-level objects for each evaluation index (for example, delivery deadline adherence, collaboration contribution, overall score), and arrays for time-series metrics. The server serializes this hierarchical structure into a text-based or binary format suitable for network transmission, such as a tagged field representation or a tree-structured document. The server applies size-optimized encoding and omits redundant fields, which reduces the amount of data transmitted to terminals and correspondingly lowers network usage and display latency.

The server exposes an information providing interface, such as a web-based application programming interface, that allows a terminal to request the structured information format based on identification information and a time range. The server supports caching and conditional retrieval so that if evaluation index data has not changed, the server returns compact responses indicating reuse of previously transmitted data. This further reduces communication overhead and computational workload on both the server and terminals.

The server uses a generative AI model not only for evaluation but also for program generation and update. The server maintains a code template and configuration repository in non-volatile storage. When the server receives a prompt sentence describing new evaluation requirements or visualization targets, for example:

“Generate a backend process that calculates on-time delivery rate, team contribution score, and error density for each worker, and exposes these metrics through an endpoint returning a structured data format for a dashboard,”
the server supplies the prompt sentence to the generative AI model. The server obtains output that describes or specifies modifications to the data acquisition process, evaluation index data generation process, or structured output format. The server then applies a controlled integration mechanism that maps this output into configuration data, parameter values, or modular code segments stored in a safe execution environment. The server may require approval by a human administrator before activating generated or updated modules. This arrangement allows the server to adapt evaluation pipelines to evolving data structures or indicators without manually rewriting monolithic code, improving maintainability and reducing configuration errors.

The terminal includes a processor, a display unit, an input interface, and a network interface. The terminal executes a browser or a dedicated application that implements an information display function. The terminal obtains the structured information format from the server via the network interface, decodes the structured information format, and constructs visualization-ready data structures. The terminal renders a graph display or a chart display of the delivery deadline adherence index, the collaboration contribution index, and the comprehensive evaluation index on the display unit. The terminal may use a visualization library to draw time-series plots, bar charts, or other diagrams directly from the structured fields. Because the server has already performed indexing, normalization, and aggregation, the terminal does not need to implement complex transformation logic, resulting in reduced computation on the terminal and consistent visualization across heterogeneous devices.

The terminal may provide interactive user controls, such as selectors for workers or time ranges. When a user changes selection, the terminal transmits new acquisition conditions to the server and updates the visualization based on newly received structured information. The terminal may also display explanation information that the server generates, indicating improvement issues and strengths. The explanation information is displayed as text synchronized with the graphical elements, enabling the user to interpret complex index data without additional local processing.

The user operates the terminal to view evaluations for individual workers or groups. The user can also provide prompt sentences to a generative AI model, either integrated with the server or accessed through an external generative AI service, to request changes in evaluation logic or dashboard behavior. For example, the user may input the following prompt sentence:

“Please generate a program to display employees'evaluation results on a dashboard. Use a server-side process to calculate on-time delivery rate and team contribution score for each employee and return the results in a structured format. The client-side application should visualize these metrics as graphs and update them when the selected employee changes.”

The user may review generated configurations or modules suggested by the generative AI model and approve them for deployment. Through this interaction, the user influences the configuration of the server without manually rewriting complex backend logic.

The described server-centric architecture produces several technical effects beyond mere automation of human evaluation. By concentrating data structure conversion and statistical calculation on the server and representing evaluation index data in a dense, cache-friendly format, the server reduces redundant computations and improves throughput for large numbers of workers and tasks. By designing a structured information format specifically optimized for visualization, the server reduces the volume of data transferred and the transformation effort required at terminals, leading to lower network load and improved display responsiveness. By integrating a generative AI model into the processing path in a controlled manner, the server can automatically derive evaluation results and program configurations from prompt sentences while still enforcing defined schemas and integration rules, thereby decreasing configuration errors and enabling rapid, technically consistent changes in evaluation pipelines.

The generative AI model and the emotion analysis model operate based on explicit model architectures and training procedures. For example, the server may implement the generative AI model as a multi-layer transformer network trained with a loss function measuring cross-entropy between predicted and actual tokens over a corpus containing descriptions of evaluation scenarios and code patterns. The server may implement the emotion analysis model as a sequence model trained with a mean squared error loss or a categorical cross-entropy loss on labeled emotion datasets. The server updates model parameters by weight update rules such as gradient descent with momentum or adaptive learning rate methods. The server can perform periodic retraining or fine-tuning using newly collected evaluation data, which leads to improved accuracy and reduced bias in evaluation results. This continuous improvement of model parameters within a defined technical infrastructure distinguishes the invention from static rule-based automation.

In alternative embodiments, the server may adopt different data structures or algorithms while maintaining the same functional framework. For example, the server may use a columnar data store to accelerate aggregation, or may apply a non-linear feature transformation such as kernel mapping before feeding features into the generative AI model. The server may represent the structured information format as a binary tree-based encoding instead of a text-based one to further reduce communication load. The server may use a different integration algorithm for generating the comprehensive evaluation index, such as a neural network that explicitly models interactions among individual indices. The emotion analysis function may be implemented as a lightweight classifier for resource-constrained environments or as a more complex model when sufficient computing resources are available. These variations demonstrate that the invention is not limited to a single implementation detail but is embodied in the specific technical combination of server-side index generation, controlled use of generative AI models with prompt sentences, emotion-aware integration into a comprehensive evaluation index, and structured data delivery optimized for machine rendering at terminals.

By focusing on concrete data structures, model architectures, and server-terminal interactions, the invention provides an improvement to computer technology itself. The server reduces processing redundancy and network usage, the models improve evaluation accuracy and adaptability through machine learning beyond simple rule-based processing, and the structured information format standardizes data exchange for visualization. These technical arrangements, working together, yield faster, more accurate, and more resource-efficient handling of complex evaluation data than conventional systems, thereby enabling reliable realization of the claimed system on general-purpose computing hardware.

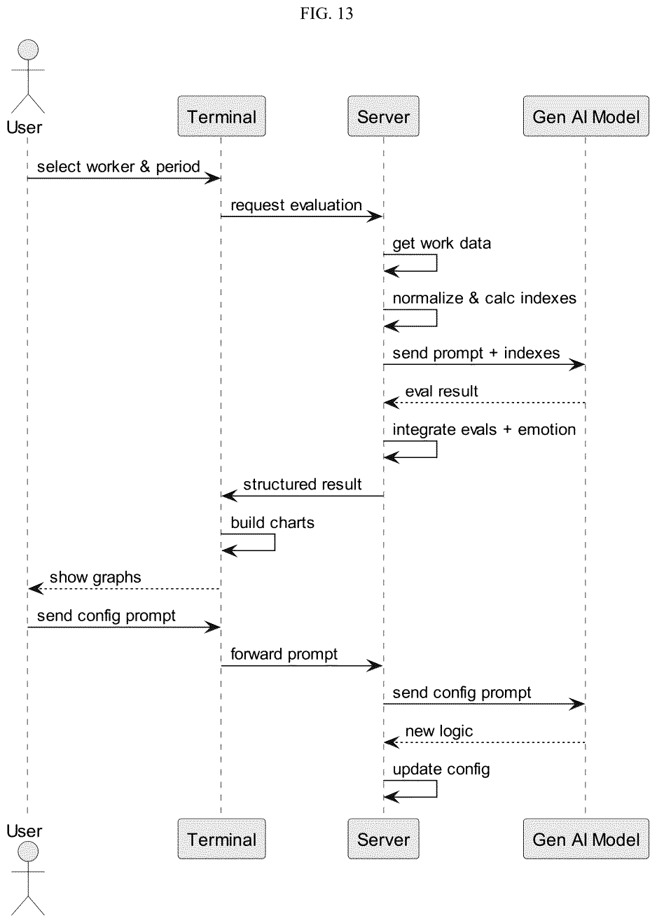

The following describes the processing flow using FIG. 13.

### Step 1:

Server receives an evaluation request from the terminal.

Server takes as input a worker identifier and a time range sent via a network request from the terminal. Server parses query parameters or a request body, validates that the worker identifier has a permitted format, and checks that the time range is within allowable limits. Server logs the request metadata and authentication information. Server outputs a validated request object that includes the worker identifier, the normalized time range, and a session identifier used in subsequent processing.

### Step 2:

Server acquires raw work activity information from a storage resource.

Server takes as input the validated request object generated in Step 1. Server constructs a data retrieval command for a storage resource, such as a structured query that filters records by the worker identifier and the time range. Server executes the data retrieval command and reads matching records from a storage resource table or collection. Server converts the raw result into an in-memory tabular structure where each row represents one work activity event with fields such as task identifier, planned deadline, completion time, status, and collaboration-related counters. Server outputs a raw data table that will be used for statistical and structural processing.

### Step 3:

Server performs data structure conversion and normalization.

Server takes as input the raw data table obtained in Step 2. Server converts timestamp strings to a unified time zone and numeric representation, maps categorical statuses to numeric codes, and reorders columns into a standard schema. Server fills missing values using predetermined rules, such as replacing absent completion times with a default placeholder or excluding invalid rows. Server creates a normalized data table in which each record has consistent data types and field order. Server outputs the normalized data table that is ready for index calculation.

### Step 4:

Server computes evaluation index data using statistical calculations.

Server takes as input the normalized data table from Step 3. Server groups records by worker identifier and aggregates within the specified time range. Server calculates a delivery deadline adherence index by counting the number of tasks whose completion time is less than or equal to the planned deadline and dividing this count by the total number of tasks in the range. Server calculates a collaboration contribution index by summing collaboration-related fields, such as review counts and collaboration events, and normalizing the sums by a baseline factor, for example, the average value across workers. Server may also compute additional indicators such as task volume or defect ratios. Server constructs a feature vector for the worker containing the delivery deadline adherence index, the collaboration contribution index, and other indicators. Server outputs evaluation index data as a feature vector or a small set of feature vectors.

### Step 5:

Server prepares model input and constructs a prompt sentence.

Server takes as input the evaluation index data produced in Step 4. Server converts each numeric indicator into a textual or structured representation, for example, “on-time delivery rate: 0.90” and “collaboration contribution index: 0.85.” Server embeds these values into a prompt sentence that describes the evaluation task for a generative AI model. For example, server constructs a prompt sentence such as: “Evaluate the worker's performance based on the following metrics: on-time delivery rate 90%, collaboration contribution index 85%, task completion volume, and defect rate. Output an overall performance score between 0 and 100 and a concise explanation.” Server formats this prompt sentence and, when applicable, also prepares a vector-based representation of the evaluation index data for hybrid conditioning. Server outputs a model input package that contains the prompt sentence and optionally the feature vector.

### Step 6:

Server executes an automatic evaluation process using a generative AI model.

Server takes as input the model input package generated in Step 5. Server encodes the prompt sentence into token embeddings and, if used, concatenates the feature vector as auxiliary conditioning data for the generative AI model. Server performs forward propagation through multiple layers of the model, computing attention weights and layer outputs according to stored model parameters. Server decodes the model output into an evaluation result that includes at least an overall performance score and possibly structured sub-scores or explanatory text. Server may apply post-processing to extract numeric values from the generative output, for example by parsing a score that appears in a prescribed output pattern. Server outputs an evaluation result of the generative AI model containing numeric scores and textual explanation segments.

### Step 7:

Server integrates multiple evaluation sources into a comprehensive evaluation index.

Server takes as input the evaluation result of the generative AI model from Step 6, together with value evaluation data and administrator evaluation data acquired from storage or input interfaces. Server applies a combination rule in which each source is assigned a weight factor. Server multiplies each individual score by its weight and sums the weighted values to produce an integrated score. Server may adjust the integrated score using calibration parameters derived from historical performance data. Server constructs a comprehensive evaluation index that includes the integrated overall score and optionally a vector of sub-indices representing efficiency, quality, and collaboration. Server outputs the comprehensive evaluation index ready for emotion-aware adjustment.

### Step 8:

Server analyzes emotion-related information and adjusts the comprehensive evaluation index.

Server takes as input the comprehensive evaluation index from Step 7 and emotion-related information retrieved from a storage resource or an emotion sensing subsystem. Server converts emotion-related information into a feature representation, such as time-windowed sentiment averages or normalized physiological indicators. Server feeds this feature representation into an emotion analysis model, computes predicted emotional attributes, and receives an analysis result that includes numeric scores for stress level, engagement, or sentiment polarity. Server applies predetermined rules or a learned mapping to adjust the comprehensive evaluation index, for example reducing the weight of short-term performance variations under extreme stress conditions. Server outputs an emotion-aware comprehensive evaluation index that incorporates both performance metrics and emotion analysis results.

### Step 9:

Server converts evaluation results into a structured information format.

Server takes as input the emotion-aware comprehensive evaluation index and the evaluation index data from Steps 4 and 8. Server maps the indices into a predefined hierarchical schema, assigning identifiers, names, and values to fields such as delivery deadline adherence index, collaboration contribution index, overall score, and time-series values. Server organizes these fields into a structured information format, for example a hierarchical or table-like representation, and attaches metadata such as time range and evaluation timestamp. Server may compress or encode the structured information format to reduce size. Server outputs the structured information format as a data object that can be transmitted to a terminal.

### Step 10:

Server provides the structured information format through an information interface.

Server takes as input the structured information format created in Step 9 and the original request context from Step 1. Server constructs a response message, sets headers indicating data type and version, and transmits the structured information format to the terminal via a network. Server may use caching headers or response tags to support incremental updates. Server outputs a completed response on the communication channel; from the server viewpoint, the output is a transmitted data stream containing the structured evaluation information.

### Step 11:

Terminal receives and decodes the structured evaluation information.

Terminal takes as input the response data stream sent by the server in Step 10. Terminal reads the response through a network stack, verifies status codes, and extracts the data payload. Terminal decodes the structured information format into internal data structures, for example, objects or arrays representing indices and time-series metrics. Terminal may perform basic validation, such as checking presence of mandatory fields and range of numeric values. Terminal outputs a visualization data set containing the delivery deadline adherence index, the collaboration contribution index, the comprehensive evaluation index, and associated metadata.

### Step 12:

Terminal generates and displays visualizations based on the evaluation information.

Terminal takes as input the visualization data set from Step 11. Terminal constructs chart-ready data arrays for each index, such as pairs of (time, value) for time-series plots or (label, value) for bar graphs. Terminal calls drawing routines within a visualization library to map these arrays to positions, shapes, and colors on a coordinate system. Terminal generates a graph display or chart display, including axes, legends, and labels, and renders the resulting image on a display unit. Terminal outputs a human-readable visualization showing the worker's performance indices and comprehensive evaluation values.

### Step 13:

User interacts with the visualization and interprets the results.

User takes as input the graphical and textual information displayed by the terminal in Step 12. User observes the values of the delivery deadline adherence index, the collaboration contribution index, and the comprehensive evaluation index, and uses the graphs to understand trends and relative performance. User may select different workers or time ranges through the terminal's input interface. When user changes the selection, the terminal generates a new request to the server, which triggers repetition of the preceding steps with new acquisition conditions. User outputs, in a logical sense, a decision or understanding based on the displayed evaluation information, though no machine-readable data is necessarily produced at this step.

### Step 14:

User provides a prompt sentence to modify or extend server-side processing via a generative AI model.

User takes as input the current understanding of evaluation requirements and formulates a prompt sentence describing desired changes, such as: “Generate a backend process that calculates on-time delivery rate, collaboration contribution index, and error density for each worker, and expose these metrics through a structured data endpoint for visualization.” User inputs this prompt sentence through a configuration interface linked to a generative AI service. User outputs the prompt sentence to the generative AI model.

### Step 15:

Server receives generative output and updates evaluation or output logic.

Server takes as input the prompt sentence and the generative AI model's output describing changes to evaluation processing, index calculation, or structured output schema. Server parses the generative output and maps it to configuration items or modular processing definitions, such as new index formulas, additional fields in the structured information format, or modified integration rules for the comprehensive evaluation index. Server validates the proposed changes and may require user confirmation. Server applies accepted changes by updating configuration storage or loading new modular processing components. Server outputs an updated processing configuration so that subsequent execution of Steps 2 through 10 follows the new evaluation pipeline defined, in part, by the prompt sentence and the generative AI model's output.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional performance evaluation systems for workers, machines, or other operational entities typically rely on simple statistical aggregation of activity logs and manual interpretation by human supervisors. Such systems suffer from several technical deficiencies in terms of computer technology.

First, existing systems often treat heterogeneous operational data (for example, operation time, processing counts, error occurrences, communication logs, and report documents) as isolated data streams and do not provide a unified feature representation optimized for automated evaluation. As a result, the underlying computing infrastructure cannot efficiently transform raw log data into high-quality feature vectors suitable for machine learning-based evaluation, which leads to suboptimal use of processing resources and degraded predictive accuracy.

Second, conventional systems usually separate automated performance metrics from human-provided evaluations and emotional information. There is no standardized, computer-implemented mechanism for integrating an automatic evaluation, a value-based evaluation, and a manager evaluation into a single comprehensive score in a reproducible way. This lack of integration forces repeated manual processing, increases latency in obtaining consistent evaluation results, and prevents the computing system from autonomously optimizing evaluation logic.

Third, known systems do not effectively incorporate user emotional state into the evaluation pipeline at the system level. Emotion-related information extracted from logs or documents, when used at all, is typically processed in an ad-hoc manner outside the core evaluation engine. As a consequence, the system cannot systematically adjust evaluation outputs or feedback generation based on inferred emotional states, and therefore cannot adapt its behavior in a technically robust, context-aware fashion.

Fourth, conventional development and configuration of such evaluation systems heavily depend on manual programming by engineers. There is no computer-implemented framework that generates or refines evaluation logic and feedback text by coordinating structured prompt sentences with a generative artificial intelligence model. This leads to high maintenance cost, slow iteration when business rules or evaluation criteria change, and inconsistent quality of feedback generated by disparate modules.

In addition, existing visualization subsystems generally output static reports or non-standard data formats that are not optimized for downstream, machine-readable consumption and interactive rendering. As a result, client devices must perform redundant data transformation for each visualization, wasting computing resources, increasing response time, and making it difficult to compare multiple targets in real time.

Accordingly, there is a need for an improved computer-implemented system and server architecture that (i) acquires and aggregates heterogeneous activity information into unified performance indices, (ii) computes automatic evaluation values using trained evaluation models, (iii) integrates those values with value evaluations and manager evaluations into a comprehensive evaluation value, (iv) analyzes emotion-related information to estimate user emotional states and reflect them in the evaluation, (v) systematically uses prompt sentences with a generative artificial intelligence model to support evaluation logic and feedback generation, and (vi) outputs the results in a machine-readable structure optimized for visualization and comparison across multiple targets. Such a system should improve the technical functioning of the computer itself by reducing processing redundancy, structuring data for efficient model inference and visualization, and enabling adaptive feedback generation in an automated and scalable manner.

The specific processing by the specific processing unit 290 of the data processing device 12 in Application Example 2 is realized by the following means.

The present invention provides a server comprising a processor configured to acquire activity information representing operational or work activities of one or more targets and store the acquired activity information in an information storage unit; aggregate the stored activity information and calculate performance indices including at least an operation time, a processing count, and a malfunction rate for each of the one or more targets; generate feature values from the calculated performance indices and from information representing daily work activities, and calculate an automatic evaluation value by inputting the feature values to a trained evaluation model; integrate the automatic evaluation value with a predetermined value evaluation and a manager evaluation based on predetermined weighting to calculate a comprehensive evaluation value; generate a prompt sentence for evaluating the daily work activities, cause a generative artificial intelligence model to perform an evaluation process or a program generation process based on the prompt sentence, and use a response result from the generative artificial intelligence model in the evaluation process; analyze emotional data by inputting emotion-related information extracted from the activity information and document information into an emotion analysis engine, estimate a user's emotional state based on an analysis result, and reflect the emotional state in the comprehensive evaluation value; and output the performance indices and the comprehensive evaluation value, in response to a request from an external apparatus, in a machine-readable format as a data structure that is displayable visually by a display device. This enables the computing system to automatically transform heterogeneous activity and emotion-related data into unified feature representations, to compute integrated and emotion-aware evaluation scores with reduced manual intervention, to leverage a generative artificial intelligence model via structured prompt sentences for dynamically supporting evaluation and feedback logic, and to provide optimized, machine-readable output structures that improve the efficiency, responsiveness, and accuracy of performance visualization and comparison across multiple targets.

The term “activity information” refers to digital data representing operational or work activities of one or more targets, including but not limited to timestamps, event types, counts of processed items, error flags, communication logs, and report contents.

The term “target” refers to an evaluation subject whose performance is to be assessed by the system, including but not limited to a worker, a group of workers, a machine, a production line, or any other operational entity.

The term “information storage unit” refers to one or more hardware and software components configured to store digital data, such as a main memory, a secondary storage device, or a database system.

The term “aggregate” refers to performing computational operations that combine multiple records of activity information over a time period or group, such as summation, counting, averaging, or grouping by identifiers or time windows.

The term “performance indices” refers to numerical or categorical indicators derived from activity information that represent performance characteristics of a target, including at least an operation time, a processing count, and a malfunction rate.

The term “operation time” refers to a duration during which a target is determined to be in an active or running state, computed from timestamps or state indicators contained in the activity information.

The term “processing count” refers to a number representing how many units of work, items, or tasks have been processed or completed by a target within a given period.

The term “malfunction rate” refers to a ratio or probability indicating a frequency of errors, failures, or abnormal events relative to a processing count or another baseline.

The term “feature values” refers to numerical or symbolic representations derived from performance indices and other information, structured as input vectors suitable for processing by a machine learning model or evaluation model.

The term “daily work activities” refers to operational actions or tasks repeatedly performed within regular work periods, such as communications, task executions, report submissions, and system interactions recorded as activity information.

The term “trained evaluation model” refers to a machine learning or statistical model that has been trained in advance using training data, and that is configured to compute an automatic evaluation value from feature values.

The term “automatic evaluation value” refers to an evaluation score or rating computed by the trained evaluation model without direct manual scoring, based on feature values derived from activity information.

The term “value evaluation” refers to an evaluation value that reflects a contribution or importance of a target's activities to a business objective or organizational goal, determined based on predefined criteria.

The term “manager evaluation” refers to an evaluation value provided by a human supervisor or administrator, representing a subjective or expert assessment of a target's performance.

The term “comprehensive evaluation value” refers to an integrated evaluation score obtained by combining an automatic evaluation value with at least a value evaluation and a manager evaluation based on predetermined weighting or integration rules.

The term “prompt sentence” refers to a text string or sequence of natural language tokens that instructs a generative artificial intelligence model to execute a specific task, such as evaluation assistance, code generation, or feedback drafting.

The term “generative artificial intelligence model” refers to an artificial intelligence model configured to generate output data such as natural language text or program code in response to an input including a prompt sentence.

The term “evaluation process” refers to a sequence of computational operations that determine one or more evaluation values or qualitative assessments for a target based on input data.

The term “program generation process” refers to a sequence of operations in which executable code, script code, or configuration code is automatically created or modified based on instructions contained in a prompt sentence.

The term “response result” refers to output data produced by the generative artificial intelligence model in response to a given prompt sentence, including but not limited to natural language text, structured data, or code.

The term “emotion-related information” refers to data that is indicative of a user's emotional state, extracted from activity information, document information, communication content, or interaction patterns.

The term “document information” refers to digital text or structured content such as reports, messages, logs, or other documents that describe activities, outcomes, or contextual information.

The term “emotion analysis engine” refers to a software component or service configured to analyze emotion-related information and output one or more indicators representing an estimated emotional state.

The term “emotional state” refers to a state of affect or sentiment associated with a user, such as stress, satisfaction, frustration, or neutrality, represented as categories, scores, or multi-dimensional vectors.

The term “external apparatus” refers to a computing device or system other than the server that issues requests to obtain performance indices, comprehensive evaluation values, or related data, such as a client terminal, another server, or a management system.

The term “machine-readable format” refers to a data encoding that can be directly processed by a computing device without human interpretation, such as a structured format including JavaScript Object Notation, Extensible Markup Language, or a binary serialization format.

The term “data structure” refers to a logically organized set of data elements, including fields, keys, and relationships, arranged for efficient storage, processing, or transmission by a computing system.

The term “display device” refers to a hardware component capable of visually presenting information to a user, such as a monitor, a tablet display, a smartphone display, or a head-mounted display.

The term “terminal device” refers to a client computing device operated by a user, such as a personal computer, a tablet, a smartphone, or a dedicated workstation, which communicates with the server to display or input data.

The term “graphical element” refers to a visual component used in a graph or chart, such as a line, bar, point, axis, label, or icon representing a data point or indicator.

The term “temporal transition” refers to a change of a value or state of a performance index over time, representable as a time series or trajectory in a visualization.

The term “comparison indicator” refers to a visual or numerical element indicating relative differences among multiple targets or time periods, such as comparative bars, overlaid lines, or normalized scores.

The term “feedback sentence” refers to a natural language text fragment that presents an assessment, recommendation, or explanation to a user, including concrete improvement items and strengths for a target.

The term “improvement item” refers to a specific action, behavior, or aspect that a target is advised to modify or enhance in order to improve performance according to the evaluation.

The term “strength” refers to a positive characteristic, capability, or pattern of behavior of a target that contributes favorably to performance according to the evaluation.

In one embodiment, a server cooperates with one or more terminal devices to implement the claimed system. The server includes at least one processor, a main memory, a non-volatile storage device, a network interface, and an information storage unit such as a database system. The server executes control programs implemented, for example, in a high-level language such as Python and deployed on a general-purpose operating system. The terminal includes a processor, a memory, a display device, and input devices, and executes a web browser or a dedicated client application.

The server stores in the information storage unit a set of activity information records. The server represents each record as a structured data object including fields such as a target identifier, a timestamp, an activity type code, a processed item count, an error flag, a communication type code, and a document reference. In one example, the server uses a relational database management system and defines a table for activity information having columns corresponding to these fields, with indexes on the target identifier and the timestamp to support efficient range queries.

The server acquires activity information from multiple sources. The server receives operation logs from control devices that manage mechanical equipment, receives work logs and communication logs from enterprise applications, and receives document identifiers referencing digital reports stored in a document management system. The server converts heterogeneous formats into a unified schema in the information storage unit. For example, the server uses a data processing library to parse date-time strings, normalize numeric units, and map varied status codes into common categorical codes. This unification reduces parsing and transformation overhead in downstream evaluation processing and improves cache locality and index utilization during query execution.

The server aggregates the stored activity information to calculate performance indices. The server executes aggregation queries over a defined evaluation period for each target. The server groups records by target identifier and by time window and computes, for each group, an operation time, a processing count, and a malfunction rate. The server calculates the operation time by summing time intervals during which the target status satisfies a running condition. The server calculates the processing count by summing deltas of processed item counts. The server calculates the malfunction rate by dividing a count of error events by the processing count. By materializing these performance indices in dedicated tables and storing them as precomputed values, the server reduces repeated computation and enables low-latency retrieval for visualization and evaluation, which improves system responsiveness compared to on-demand recalculation from raw logs.

The server generates feature values from the performance indices and from additional information representing daily work activities. The server constructs, for each target and evaluation period, a feature vector including, for example, average operation time per period, variance of operation time, average processing count per period, trend values computed as differences between recent and historical averages, malfunction rate, frequency of communication events, and document submission frequency. The server normalizes each dimension using stored scaling parameters learned during a training phase. This normalization stabilizes the input distribution for a trained evaluation model and reduces numerical instability during inference.

The server applies a trained evaluation model to the feature values to calculate an automatic evaluation value. In one embodiment, the server uses a neural network model with multiple layers, such as an input layer corresponding to the feature dimensions, one or more fully connected hidden layers with non-linear activation functions, and an output layer producing a scalar evaluation score. The server stores model parameters, including weight matrices and bias vectors, in a model storage area. During inference, the server performs a sequence of linear algebra operations: matrix multiplications, additions, and non-linear activation operations such as rectified linear units. The server computes the automatic evaluation value as the final output of the model for the given feature vector. Because the server structures the feature values and the neural network in this way, the server can exploit vectorized numerical libraries and hardware acceleration, improving computational efficiency and throughput compared to manual or rule-based scoring.

The server trains the evaluation model in advance using supervised learning. The server prepares a training data set by pairing historical feature vectors with target evaluation values obtained from expert assessments or composite scores. The server selects a loss function, such as a mean squared error between predicted scores and target scores, and performs iterative optimization using gradient-based methods. The server computes gradients of the loss with respect to the model parameters via backpropagation, updates the parameters according to a learning rate and optional regularization terms, and repeats until convergence criteria are satisfied. The server may perform data augmentation at the feature level, for example by injecting noise into non-critical dimensions or by generating synthetic time windows, to improve model robustness. This training procedure allows the server to learn non-linear relationships between heterogeneous activity patterns and evaluation scores that cannot be efficiently encoded by simple rule sets, thereby improving accuracy and generalization.

The server integrates the automatic evaluation value with a value evaluation and a manager evaluation to compute a comprehensive evaluation value. The server stores value evaluations and manager evaluations as separate tables indexed by target identifier and evaluation period. The server retrieves these values, aligns them with the automatic evaluation value, and computes an integrated score using a predetermined weighting formula or a learned combination function. In a simple case, the server performs a weighted sum operation. In an alternative embodiment, the server applies a secondary model that takes the three evaluations as inputs and outputs a combined score. This integration within the processor reduces human intervention and ensures consistent application of combination rules, which improves reproducibility and reduces evaluation latency.

The server analyzes emotion-related information to estimate a user's emotional state and to reflect the emotional state in the comprehensive evaluation value. The server extracts emotion-related information from communication logs, document contents, and interaction patterns such as activity timing. The server transforms each text instance into a numerical representation using, for example, a sequence embedding generated by a neural network that processes tokens of the text. The server provides the embeddings and contextual metadata to an emotion analysis engine comprising a classification model that outputs probabilities for emotion categories or continuous sentiment scores. The server computes an emotional state representation, such as a vector with dimensions for stress, satisfaction, and fatigue. The server then incorporates this representation into the comprehensive evaluation calculation, for example by adjusting weights, applying penalty terms when stress exceeds a threshold, or augmenting the input of the secondary combination model. This approach allows the server to adjust scores in a structured, algorithmic manner based on emotional signals, instead of relying on manual interpretation, and results in more stable and context-sensitive evaluation outputs.

The server uses a generative artificial intelligence model in conjunction with structured prompt sentences to support evaluation and feedback logic. The server generates a prompt sentence that describes an evaluation task, a data schema, or a desired program behavior. The server sends this prompt sentence to a remote or local generative artificial intelligence model via an application programming interface. The server receives a response result including, for example, analytical descriptions, evaluation rules in natural language, or code snippets that implement specific data processing functions. The server uses this output to refine evaluation criteria, to propose new feature definitions, or to generate feedback sentences. Because the server structures the prompt sentences based on internal data structures and evaluation states, the generative artificial intelligence model operates as a controlled extension of the evaluation pipeline rather than a generic text generator. This controlled interaction improves maintainability and enables automated adaptation of evaluation logic without manual reprogramming of complex rule sets.

The server may use the generative artificial intelligence model to generate feedback sentences for individual targets. The server constructs a prompt sentence that includes the comprehensive evaluation value, key performance indices, and selected emotional state indicators as textual context. An example prompt sentence is:

“Based on the following evaluation data, generate a feedback message that describes strengths and specific improvement items in a professional tone. Evaluation score: 86.5. Strengths: stable throughput, low malfunction rate. Weaknesses: slightly increasing error trend in the last two hours.”

The server sends this prompt sentence to the generative artificial intelligence model and receives a natural language text output. The server optionally post-processes the output to conform to formatting or policy rules and stores the feedback sentence. The terminal then displays the feedback sentence to the user. This arrangement allows the server to generate consistent and context-aware feedback while keeping the underlying evaluation scores and features under programmatic control.

The server can also request the generative artificial intelligence model to assist in configuring or extending system functionalities. For example, the server may send a prompt sentence such as:

“Create a function specification that takes as input aggregated performance indices (operation time, processing count, malfunction rate) and returns normalized feature vectors suitable for a neural network evaluation model.”

The server receives the specification description from the generative artificial intelligence model and uses it as guidance for updating internal data processing modules. This interaction supports rapid prototyping and adaptation of the evaluation pipeline while preserving a consistent architectural pattern managed by the server.

The terminal receives from the server a data structure that encodes performance indices and comprehensive evaluation values in a machine-readable format. The terminal, executing a web browser or client application, interprets the data structure and renders visualizations on the display device. The terminal generates graphs or charts including graphical elements that represent temporal transitions of the indices and comparative indicators among multiple targets. Because the server has pre-aggregated and normalized the data, the terminal avoids expensive computations on the client side and can focus on rendering operations, which results in faster user interface response and reduced network bandwidth usage.

The user operates the terminal to request evaluation results and visualizations for particular targets and time ranges. The user may select multiple targets to display overlapping performance curves or side-by-side charts. The user may also open a feedback view where the terminal displays feedback sentences generated as described above. Based on the comprehensive evaluation values and visualized trends, the user may adjust resource allocation, schedule maintenance for equipment, or modify operational policies. In this way, the system couples internal computational improvements with tangible control and configuration of real-world equipment and workflows.

The described configuration improves computer technology in several ways. The server reduces redundant computations by separating raw activity logs, aggregated performance indices, and feature vectors into distinct layers and by precomputing reusable indices. The server improves accuracy and robustness by using a trained evaluation model that captures non-linear relationships among heterogeneous features, and by systematically integrating emotional state estimates into evaluation logic. The server improves maintainability and adaptability of the evaluation pipeline by using prompt sentences with a generative artificial intelligence model to propose or generate evaluation and feedback specifications under programmatic control. The server and terminal together reduce latency and communication load by transmitting compact, structured data optimized for visualization instead of sending raw logs or unstructured reports.

Multiple alternative embodiments are possible. In one variation, the server employs a different model architecture, such as a gradient boosting model, while maintaining the same feature generation and integration mechanism. In another variation, the emotion analysis engine uses a rule-based classifier for environments where machine learning resources are limited. In a further variation, the server deploys the generative artificial intelligence model locally for high-security installations, while using the same prompt sentence structure for consistent behavior. In all these embodiments, the server, the terminal, and the user interact according to the structural and functional relationships described above, enabling the system to implement the claimed invention in a manner that can be realized by a person skilled in the art.

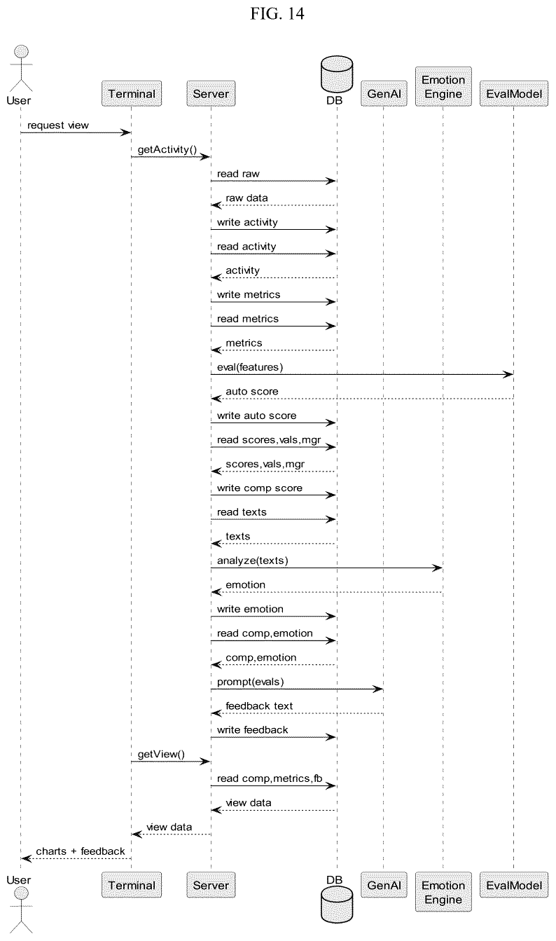

The following describes the processing flow using FIG. 14.

### Step 1:

The server acquires raw activity information.

The server receives, as input, heterogeneous digital records from log sources such as control devices, enterprise applications, and document management systems. The input includes fields such as target identifiers, timestamps, status codes, processed item counters, error flags, communication types, and document references. The server parses the raw records, converts timestamps into a uniform time format, normalizes numeric units, and maps source-specific status codes to unified categorical codes. The server then stores the normalized records as rows in an activity information table in a database. The output of this step is a set of normalized activity records indexed by target identifier and timestamp.

### Step 2:

The server aggregates activity information into performance indices.

The server reads, as input, normalized activity records for a specified evaluation period and set of targets from the activity information table. The server groups the records by target identifier and by time window and computes, for each group, the operation time by summing durations where the status satisfies a running condition, the processing count by summing differences in processed item counters, and the malfunction rate by dividing the number of error events by the processing count. The server performs these data operations using aggregation queries and arithmetic functions. The server writes the aggregated values into a performance index table. The output of this step is a collection of performance index records (operation time, processing count, malfunction rate) per target and time window.

### Step 3:

The server generates feature values from the performance indices and daily work activity information.

The server retrieves, as input, performance index records and related daily work activity information such as communication frequencies and document submission counts for each target. The server constructs feature vectors by combining values such as average operation time per interval, variance of operation time, average processing count, recent changes in throughput, malfunction rate, communication event counts, and report frequencies. The server normalizes each feature dimension using stored scaling parameters (for example, subtracting means and dividing by standard deviations) to create standardized inputs for a trained evaluation model. The output of this step is a set of normalized feature vectors associated with targets and evaluation periods.

### Step 4:

The server calculates automatic evaluation values using a trained evaluation model.

The server inputs the feature vectors into a trained evaluation model stored in memory. The evaluation model may be a neural network with multiple layers, so the server performs matrix multiplications, bias additions, and activation function computations to propagate the feature vectors through the model. The server calculates, for each input vector, an automatic evaluation value, such as a scalar score in a predefined range. The server stores these scores in an automatic evaluation table linked to target identifiers and periods. The output of this step is a set of automatic evaluation values corresponding to the input feature vectors.

### Step 5:

The server integrates the automatic evaluation values with value evaluations and manager evaluations to compute comprehensive evaluation values.

The server receives, as input, automatic evaluation values from the automatic evaluation table, value evaluations from a value evaluation table, and manager evaluations from a manager evaluation table, all aligned by target and evaluation period. The server merges these values and applies a predetermined integration function, such as a weighted sum or a secondary model, to compute a comprehensive evaluation value. The server then stores the computed comprehensive evaluation values in a comprehensive evaluation table. The output of this step is a comprehensive evaluation value for each target and evaluation period.

### Step 6:

The server analyzes emotion-related information to estimate a user's emotional state.

The server obtains, as input, emotion-related information extracted from activity records and document information, such as text messages, report contents, and interaction timing patterns. The server converts text into numerical representations (for example, embeddings) and feeds these, along with contextual features, into an emotion analysis engine. The server executes the engine's classification or regression operations to compute one or more emotion scores, such as stress level or satisfaction level, for each user. The server stores the emotion scores as emotional state records associated with user identifiers and time periods. The output of this step is an estimated emotional state per user.

### Step 7:

The server reflects the emotional state in the comprehensive evaluation values.

The server reads, as input, comprehensive evaluation values from the comprehensive evaluation table and emotional state records from the emotion state storage for the corresponding users and time periods. The server applies adjustment rules or a combination function that modifies or augments the comprehensive evaluation values based on emotion scores, for example by applying penalty factors when stress exceeds a threshold or by adjusting weights for certain components. The server updates the comprehensive evaluation table or stores adjusted evaluation values in a separate structure. The output of this step is an emotion-adjusted comprehensive evaluation value for each relevant target.

### Step 8:

The server generates prompt sentences for a generative ai model based on evaluation data.

The server collects, as input, performance indices, emotion-adjusted comprehensive evaluation values, and selected emotional state indicators for one or more targets. The server formats this information into a structured natural language description that includes key metrics, strengths, and weaknesses. The server constructs a prompt sentence that specifies the task for the generative AI model, such as generating feedback or suggesting feature refinements, and embeds the collected data into the prompt. The output of this step is a text-form prompt sentence ready to be sent to a generative AI model.

### Step 9:

The server transmits the prompt sentence to a generative AI model and receives a response result.

The server sends, as input, the prompt sentence created in the preceding step to an external or internal generative AI model through an application programming interface. The server specifies parameters such as the model name and length limits. The server then receives a response result from the generative AI model, typically natural language text that includes analysis, suggested rules, or candidate feedback sentences. The server stores the response result in association with the original prompt and evaluation context. The output of this step is the generative AI model's response text corresponding to the prompt sentence.

### Step 10:

The server generates feedback sentences for individual targets using the response result.

The server takes, as input, the response text from the generative AI model and the underlying evaluation data such as performance indices and emotion-adjusted comprehensive evaluation values. The server optionally parses or filters the response to extract segments describing strengths and improvement items. The server composes a feedback sentence for each target, ensuring that the text refers to specific metrics and observed trends. The server stores these feedback sentences in a feedback table linked to target identifiers and evaluation periods. The output of this step is a set of finalized feedback sentences tailored to each target.

### Step 11:

The server outputs performance indices, comprehensive evaluation values, and feedback in a machine-readable format.

The server receives, as input, a query from an external apparatus or terminal specifying target identifiers and a time range. The server retrieves the corresponding performance indices, emotion-adjusted comprehensive evaluation values, emotional state indicators, and feedback sentences from the database. The server assembles this information into a structured data object, such as a collection of records grouped by target and time, and encodes it in a machine-readable format suited for network transmission. The output of this step is a machine-readable data structure containing the requested evaluation and feedback information.

### Step 12:

The terminal requests and receives the evaluation data from the server.

The terminal sends, as input, a request message to the server specifying which targets and time intervals the user wishes to inspect. The terminal receives from the server the machine-readable data structure containing performance indices, comprehensive evaluation values, emotional state indicators, and feedback sentences. The terminal parses the received data into in-memory objects suitable for visualization and text display. The output of this step is a set of visualizable and readable data elements stored on the terminal.

### Step 13:

The terminal visualizes the performance indices and comprehensive evaluation values.

The terminal accepts, as input, the parsed performance indices and comprehensive evaluation values. The terminal maps time-series values to chart coordinates, creates graphical elements such as lines, bars, and markers, and renders graphs showing temporal transitions and comparative indicators for multiple targets on the display device. The terminal may compute additional display-only statistics, such as relative differences, for labeling. The output of this step is a graphical user interface containing interactive graphs and charts visible to the user.

### Step 14:

The terminal displays feedback sentences and emotional state information to the user.

The terminal receives, as input, the feedback sentences and the associated emotional state indicators for each target. The terminal formats the feedback sentences in a readable layout, optionally highlighting segments related to strengths and improvement items. The terminal displays the emotional state indicators alongside the corresponding evaluation scores, for example as icons or colored labels. The output of this step is a feedback view that presents evaluation results and emotional context to the user on the display device.

### Step 15:

The user reviews the visualized information and feedback to make decisions.

The user views, as input, the graphs, charts, feedback sentences, and emotional state indicators presented by the terminal. The user interprets trends such as changes in malfunction rates, variations in comprehensive evaluation values, and shifts in emotional state. Based on this information, the user decides outputs such as scheduling maintenance for machines, adjusting workload distribution, or initiating training or support actions for personnel. These decisions constitute outputs that affect subsequent operational configurations or external control systems, closing the loop between the computational processing and real-world actions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

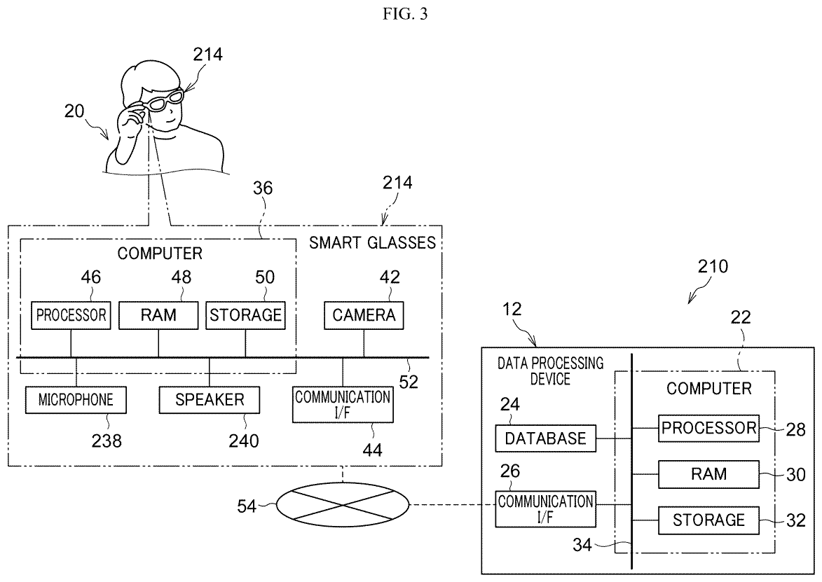

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

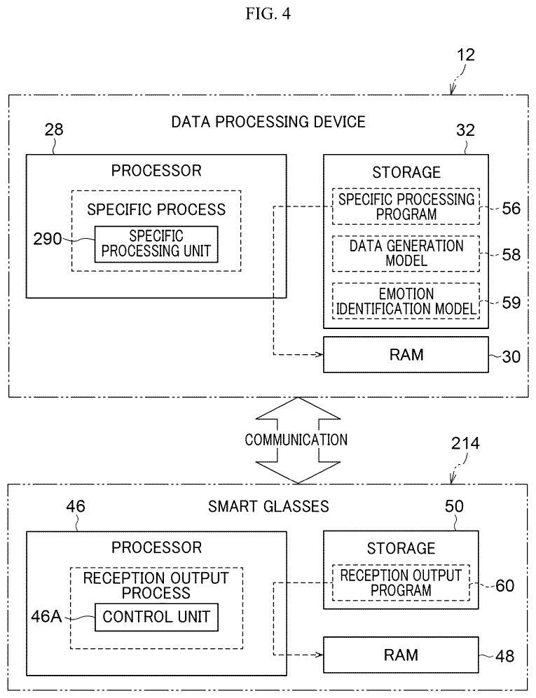

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

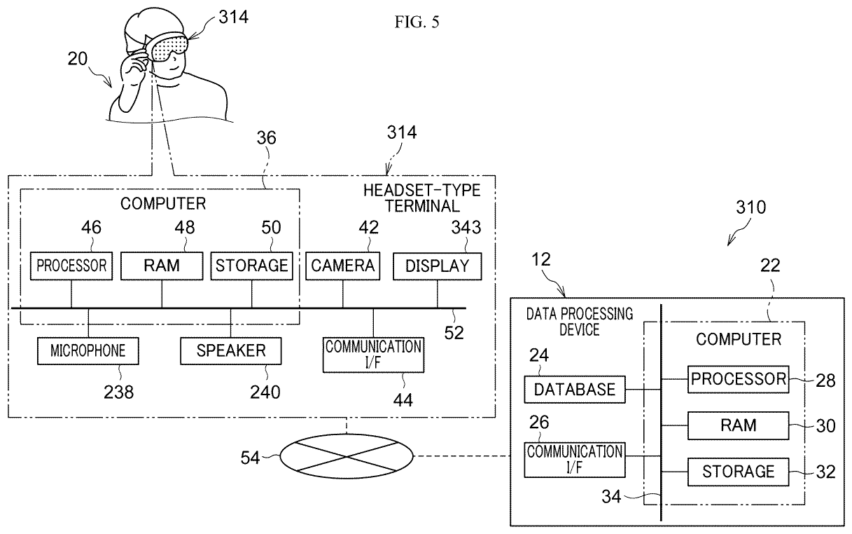

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

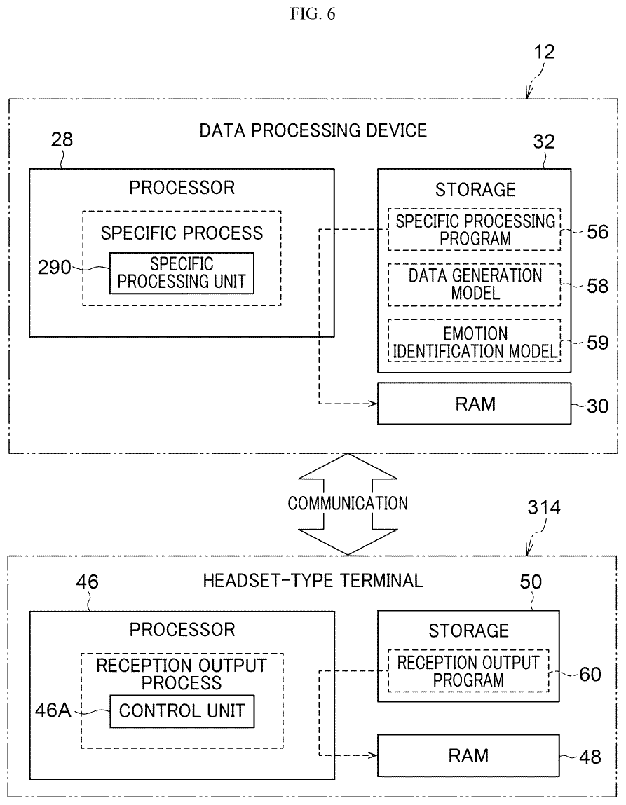

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

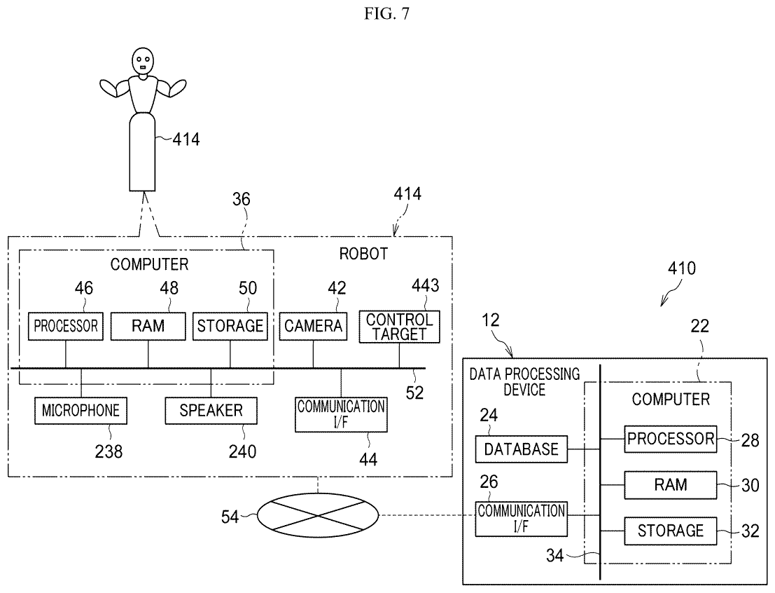

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

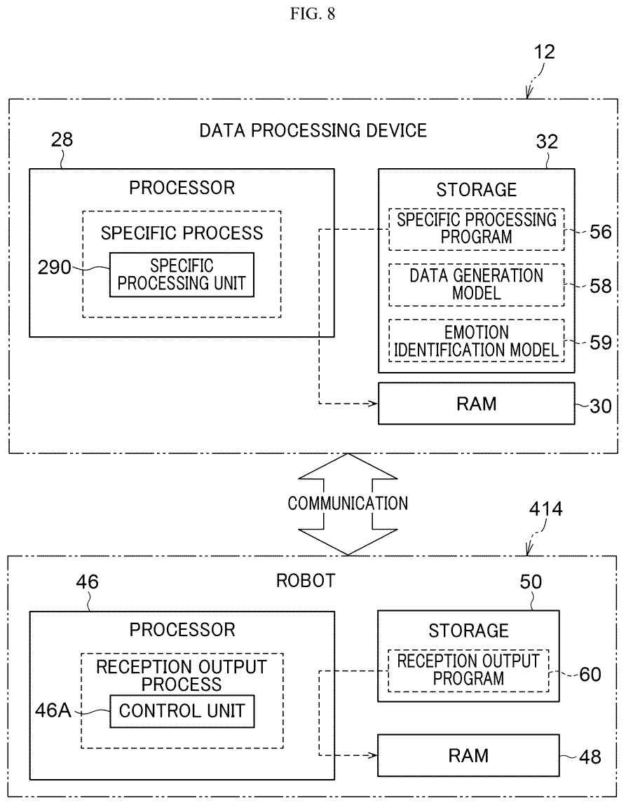

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

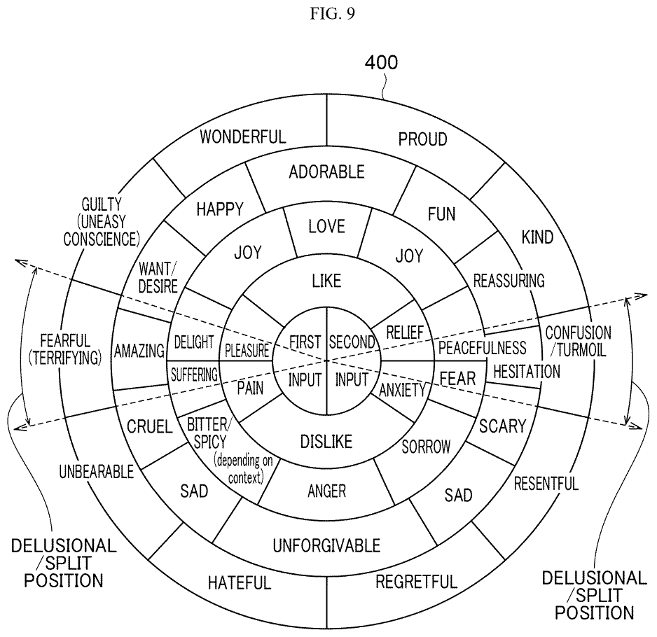

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

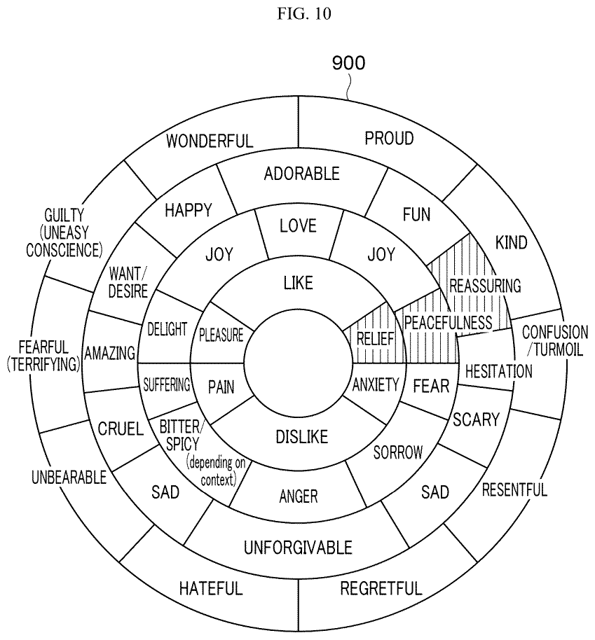

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
collect, from a user terminal, a plurality of types of activity data indicating daily work activities of a worker, and store the activity data as structured data in a storage resource,
   preprocess the activity data as numerical features and textual information, and convert a result of the preprocessing into an input format for a generative artificial intelligence model,
automatically generate a prompt sentence for the generative artificial intelligence model based on the result of the preprocessing, input the prompt sentence to the generative artificial intelligence model, and thereby automatically obtain evaluation information regarding work performance of the worker,
integrate the evaluation information obtained from the generative artificial intelligence model, value-based evaluation information based on a value criterion, and evaluation information provided by a manager, in accordance with a predetermined weighting algorithm, and calculate an integrated evaluation result,
analyze emotion data obtained by an emotion analysis component in association with the integrated evaluation result, and reflect an analysis result of the emotion data in the integrated evaluation result, and
generate, based on the integrated evaluation result and the analysis result of the emotion data, evaluation summary text and feedback text for the worker, and store the text as output data in the storage resource.

### Supplementary 2

The system according to supplementary 1,
wherein the processor is configured to
aggregate the integrated evaluation result and the evaluation information obtained from the generative artificial intelligence model as time-series information and factor-wise information, and generate display data that visually represents the information as a graph or chart on a display screen of the user terminal.

### Supplementary 3

The system according to supplementary 1,
wherein the processor is configured to
generate, based on the integrated evaluation result and the analysis result of the emotion data, feedback information indicating specific improvement points and strengths for each worker, and transmit the feedback information to the user terminal for display.

### Application Example 1

### Supplementary 1

A system comprising a processor,
wherein the processor is configured to
collect behavioral information indicating business activities of human subjects and operation information indicating operating states of equipment from an information processing apparatus, an information exchange apparatus, a conferencing apparatus, a report management apparatus, and a detection apparatus via a communication function, and store the collected behavioral information and operation information in a storage apparatus as recorded information, and perform preprocessing including information extraction processing, missing-value completion processing, normalization processing, and aggregation processing on the recorded information to generate evaluation input information; and
generate a first prompt sentence that instructs a generative AI model to perform evaluation based on at least a portion of the evaluation input information relating to the business activities, transmit the first prompt sentence to the generative AI model, and automatically acquire first evaluation information regarding the business activities from the generative AI model; and
input at least a portion of the evaluation input information relating to the operation information into a trained inference model that executes numerical computation processing, and calculate second evaluation information including efficiency information, reliability information, and failure prediction information regarding the equipment; and
obtain value evaluation information and manager evaluation information regarding the human subjects, and input the first evaluation information, the value evaluation information, and the manager evaluation information into an integration evaluation model to perform integration evaluation processing, thereby calculating comprehensive evaluation information, and associate the comprehensive evaluation information with the second evaluation information to generate an overall evaluation result for each evaluation target; and
input emotion-related information into an emotion analysis engine to obtain an emotion analysis result indicating an emotional state of a user, and perform correction processing that reflects the emotion analysis result in the comprehensive evaluation information; and
generate a second prompt sentence for the generative AI model based on at least the comprehensive evaluation information, the second evaluation information, and the emotion analysis result, transmit the second prompt sentence to the generative AI model to cause the generative AI model to generate feedback information expressed in natural language, and store the feedback information in association with a corresponding evaluation target; and
convert the comprehensive evaluation information and the feedback information into output information and provide the output information in a form displayable on a display apparatus.

### Supplementary 2

The system according to supplementary 1,
wherein the processor is configured to
generate, as at least a portion of the output information, visual information in a chart format by aggregating the comprehensive evaluation information and the second evaluation information by time information or by evaluation target, and outputting the aggregated information as line graphs, bar graphs, radar charts, or other graphical formats to the display apparatus.

### Supplementary 3

The system according to supplementary 1,
wherein the processor is configured to
generate, for generation of the feedback information, a third prompt sentence including structured information containing at least the comprehensive evaluation information, the second evaluation information, and the emotion analysis result, and including constraint conditions requesting presentation of improvement points and strengths, input the third prompt sentence into the generative AI model, and thereby cause the generative AI model to generate the feedback information in natural language including specific improvement points and strengths for each evaluation target, and provide the feedback information to individual workers or equipment.

### Example 2

### Supplementary 1

A system comprising a processor,
wherein the processor is configured to
acquire work activity information from an information storage unit based on acquisition conditions including identification information and a time range, and generate evaluation index data including a delivery deadline adherence index and a collaboration contribution index by using a data structure conversion function and a statistical calculation function, and
execute an automatic evaluation process by using the evaluation index data and a prompt sentence for causing a generative information processing model to perform evaluation, and generate a comprehensive evaluation index by integrating an evaluation result of the generative information processing model, a value evaluation, and an administrator evaluation, and
analyze emotion-related information by using an information processing function having an emotion analysis function, and reflect an analysis result in the comprehensive evaluation index, and
convert the comprehensive evaluation index and the evaluation index data into a structured information format and output the structured information format through an information providing interface that is accessible from an external information processing apparatus, and
generate or update a program that, when a prompt sentence is input to the generative information processing model, causes execution of a work activity information acquisition process, an evaluation index data generation process, the automatic evaluation process, and an output process in the structured information format.

### Supplementary 2

The system according to supplementary 1,
wherein the processor is configured to
cause an information display function operating on the external information processing apparatus that has acquired the structured information format to visualize the delivery deadline adherence index, the collaboration contribution index, and the comprehensive evaluation index as a graph display or a chart display including time-series display.

### Supplementary 3

The system according to supplementary 1,
wherein the processor is configured to
automatically generate explanation information indicating improvement issues and strengths based on the comprehensive evaluation index, the analysis result of the emotion-related information, and the evaluation index data, and present the explanation information to an individual worker or an administrator.

### Application Example 2

### Supplementary 1

A system comprising a processor,
wherein the processor is configured to
acquire activity information representing operational or work activities of one or more targets, and store the acquired activity information in an information storage unit,
aggregate the stored activity information and calculate performance indices including at least an operation time, a processing count, and a malfunction rate for each of the one or more targets,
generate feature values from the calculated performance indices and from information representing daily work activities, and calculate an automatic evaluation value by inputting the feature values to a trained evaluation model,
integrate the automatic evaluation value with a predetermined value evaluation and a manager evaluation based on predetermined weighting to calculate a comprehensive evaluation value,
generate a prompt sentence for evaluating the daily work activities, cause a generative artificial intelligence model to perform an evaluation process or a program generation process based on the prompt sentence, and use a response result from the generative artificial intelligence model in the evaluation process,
analyze emotional data by inputting emotion-related information extracted from the activity information and document information into an emotion analysis engine, estimate a user's emotional state based on an analysis result, and reflect the emotional state in the comprehensive evaluation value, and
output the performance indices and the comprehensive evaluation value, in response to a request from an external apparatus, in a machine-readable format as a data structure that is displayable visually by a display device.

### Supplementary 2

The system according to supplementary 1,
wherein the processor is configured to cause a terminal device, based on the data structure provided to the display device, to visualize the performance indices and the comprehensive evaluation value as graphs or charts including graphical elements representing temporal transitions and comparison indicators, so that a user can simultaneously compare performance of a plurality of targets.

### Supplementary 3

The system according to supplementary 1,
wherein the processor is configured to generate and transmit a prompt sentence to the generative artificial intelligence model based on the comprehensive evaluation value and the emotional state, acquire natural language text from the generative artificial intelligence model in response to the prompt sentence, automatically generate, for each of the one or more targets, a feedback sentence including concrete improvement items and strengths using the natural language text, and provide the feedback sentence to the user via a terminal device.

What is claimed is:

1. A system comprising:
circuitry configured to:
acquire, via a communication interface coupled to a packet-switched network, a plurality of activity data records from one or more external information processing apparatuses, the activity data records comprising communication event records, session participation records, and text-based report data associated with an entity identifier;
preprocess the activity data records by extracting numerical feature values and textual feature data, and convert the preprocessed data into a structured input format;
construct a constrained instruction sequence based on the structured input format, and input the constrained instruction sequence into a generative neural network model comprising a transformer-based architecture to generate first assessment data representing an automated analysis of the activity data records;
acquire criterion-based assessment data and supervisor input data from the information storage device or from a terminal device, and compute a composite assessment score by applying a weighted integration operation to the first assessment data, the criterion-based assessment data, and the supervisor input data;
acquire affective state data associated with the entity identifier, compute an affective state classification using a neural network classifier, and adjust the composite assessment score based on the affective state classification; and
generate output data comprising summary text data and recommendation data based on the adjusted composite assessment score and the affective state classification, and store the output data in an information storage device.

2. The system according to claim 1, wherein the circuitry is further configured to:
extract the numerical feature values by computing count metrics, duration metrics, and frequency metrics from the communication event records and the session participation records, and extract the textual feature data by applying a natural language processing operation to the text-based report data to generate embedding vectors.

3. The system according to claim 2, wherein the circuitry is further configured to:
include, in the constrained instruction sequence, the numerical feature values and the embedding vectors together with assessment dimension parameters specifying a plurality of evaluation categories, and instruct the generative neural network model to produce the first assessment data as category-specific scores for each evaluation category.

4. The system according to claim 3, wherein the weighted integration operation comprises:
assigning a first weighting coefficient to the first assessment data, a second weighting coefficient to the criterion-based assessment data, and a third weighting coefficient to the supervisor input data, computing a weighted sum of category-specific scores across the three data sources for each evaluation category, and normalizing the weighted sum to produce the composite assessment score.

5. The system according to claim 4, wherein the circuitry is further configured to:
adjust the first, second, and third weighting coefficients based on a reliability metric computed for each data source, the reliability metric derived from a completeness of the activity data records, a consistency of the criterion-based assessment data, and a variance of the supervisor input data.

6. The system according to claim 1, wherein the circuitry is further configured to:
compute the affective state classification by inputting the affective state data into the neural network classifier trained on labeled affective-state samples, and apply an adjustment function to the composite assessment score that increases or decreases the composite assessment score by a correction value proportional to a deviation of the affective state classification from a baseline affective state.

7. The system according to claim 6, wherein the circuitry is further configured to:
generate the recommendation data by inputting the adjusted composite assessment score and the affective state classification into the generative neural network model with a feedback-generation instruction sequence specifying identification of positive attribute indicators and remediation indicators, and acquiring the recommendation data as structured text identifying specific positive attributes and specific remediation targets.

8. The system according to claim 1, wherein the circuitry is further configured to:
aggregate the composite assessment scores for the entity identifier over a plurality of time periods to generate time-series assessment data, and generate visualization data representing the time-series assessment data as chart data comprising data point coordinates, axis labels, and series identifiers for rendering on a display of the terminal device.

9. The system according to claim 8, wherein the circuitry is further configured to:
decompose the visualization data by evaluation category to generate category-specific chart data, and generate comparative visualization data representing the composite assessment score of the entity relative to aggregated composite assessment scores of a plurality of entities within a same organizational group.

10. The system according to claim 1, wherein the generative neural network model comprises:
an embedding layer configured to convert input tokens into multidimensional tensor representations, a positional encoding module, a plurality of transformer layers each comprising multi-head self-attention and feed-forward sublayers with layer normalization, and a decoding stage configured to generate a probability distribution over a vocabulary and select output tokens using a sampling strategy.

11. The system according to claim 1, wherein the circuitry is further configured to:
validate the first assessment data by verifying that each category-specific score falls within a predefined score range, and when a category-specific score exceeds the predefined score range, re-input a correction instruction sequence into the generative neural network model to obtain corrected first assessment data.

12. The system according to claim 1, wherein the circuitry is further configured to:
acquire the affective state data by analyzing text content within the text-based report data using a sentiment analysis neural network to compute sentiment scores, and derive the affective state classification from the sentiment scores.

13. The system according to claim 7, wherein the circuitry is further configured to:
transmit the recommendation data to the terminal device via the communication interface, acquire acknowledgment data or response data from the terminal device, and update the constrained instruction sequence for a subsequent assessment cycle based on the response data.

14. The system according to claim 1, wherein the circuitry is further configured to:
acquire the activity data records on a periodic schedule from the one or more external information processing apparatuses, incrementally update the structured input format, and recompute the composite assessment score at each period to maintain a continuously updated assessment.

15. The system according to claim 1, wherein the circuitry is further configured to:
apply an anonymization operation to the activity data records by replacing the entity identifier with a pseudonymous identifier before inputting the structured input format into the generative neural network model, and re-associate the first assessment data with the entity identifier after generation.

16. The system according to claim 1, wherein the circuitry is further configured to:
compute a goal attainment metric by comparing the composite assessment score against target values stored in the information storage device, and include the goal attainment metric in the output data.

17. The system according to claim 7, wherein the activity data records comprise employee work activity logs including email counts, meeting attendance records, and daily work reports, the criterion-based assessment data comprises organizational value alignment scores, the supervisor input data comprises manager performance ratings, the composite assessment score represents an employee performance evaluation, the recommendation data comprises personalized feedback identifying specific professional strengths and improvement areas, and the visualization data represents employee performance trends for a human resources evaluation system.

18. A system comprising:
circuitry configured to:
acquire activity data records associated with an entity identifier from one or more external information processing apparatuses via a communication interface coupled to a packet-switched network;
preprocess the activity data records and construct a constrained instruction sequence, and input the constrained instruction sequence into a generative neural network model to generate first assessment data;
compute a composite assessment score by integrating the first assessment data with criterion-based assessment data and supervisor input data;
acquire affective state data, compute an affective state classification, and adjust the composite assessment score based on the affective state classification; and
generate output data comprising summary text data and recommendation data based on the adjusted composite assessment score.

19. The system according to claim 18, wherein the circuitry is further configured to:
aggregate the composite assessment scores over a plurality of time periods and generate visualization data representing the time-series assessment data for rendering on a terminal device.

20. A method comprising:
acquiring, by circuitry via a communication interface coupled to a packet-switched network, a plurality of activity data records from one or more external information processing apparatuses, the activity data records comprising communication event records, session participation records, and text-based report data associated with an entity identifier;
preprocessing the activity data records by extracting numerical feature values and textual feature data, and converting the preprocessed data into a structured input format;
constructing a constrained instruction sequence based on the structured input format, and inputting the constrained instruction sequence into a generative neural network model comprising a transformer-based architecture to generate first assessment data;
computing a composite assessment score by applying a weighted integration operation to the first assessment data, criterion-based assessment data, and supervisor input data;
acquiring affective state data, computing an affective state classification using a neural network classifier, and adjusting the composite assessment score based on the affective state classification; and
generating output data comprising summary text data and recommendation data based on the adjusted composite assessment score and the affective state classification.
